(19) United States
(12) Patent Application Publication
(10) Pub. No.: US 2025/0206138 A1
(43) Pub. Date: Jun. 26, 2025

(54) DISPLAY CONTROL DEVICE, METHOD, AND STORAGE MEDIUM

(71) Applicant: TOYOTA JIDOSHA KABUSHIKI KAISHA, Toyota-shi Aichi-ken (JP)

(72) Inventors: Hideki TSUDA, Nagoya-shi Aichi-ken (JP); Go MATSUNOBU, Okazaki-shi Aichi-ken (JP); Kazuhisa ISHIMARU, Nagoya-shi Aichi-ken (JP)

(73) Assignee: TOYOTA JIDOSHA KABUSHIKI KAISHA, Toyota-shi Aichi-ken (JP)

(21) Appl. No.: 18/987,014

(22) Filed: Dec. 19, 2024

(30) Foreign Application Priority Data
Dec. 21, 2023 (JP) 2023-216051

(51) Int. Cl. B60K 35/29; B60K 35/233; B60K 35/28

(52) U.S. Cl. CPC B60K 35/29; B60K 35/233; B60K 35/28; B60K 2360/179; B60K 2360/188

(57) ABSTRACT

A display control device includes a display control unit that causes a marker to be displayed in a display area of a display device in a position corresponding to an object included in a foreground of a vehicle visible through the display area of the display device or in an image resembling the foreground of the vehicle displayed in the display area of the display device, and the marker comprising a plurality of partial images lined up next to and spaced apart from each other in a vehicle width direction and having sides along a lengthwise direction of the partial images that are not parallel to a vehicle vertical direction.

### CROSS-REFERENCE TO RELATED APPLICATION

This application is based on and claims priority under 35 USC 119 from Japanese Patent Application No. 2023-216051 filed on Dec. 21, 2023, the disclosure of which is incorporated by reference herein.

### BACKGROUND

### Technical Field

The present disclosure relates to a display control device, a display control method, a program product, and a non-transitory storage medium storing a display control program.

### Related Art

Japanese Patent No. 6,536,855 discloses a technology which, when a vehicle is following a preceding vehicle in front of the vehicle, causes a marker to be displayed on a head-up display (HUD) so that the marker is superimposed on the preceding vehicle.

When causing a marker to be displayed in a position corresponding to an object such as a preceding vehicle, the precision with which the position of the object is detected fluctuates due, for example, to the color of the object and the distance to the object, so sometimes the marker is displayed in a position that is offset relative to the object. In this case, the degree to which the offset in the position of the marker is perceived by the user differs due to the shape of the marker, and depending on the shape of the marker, offset in the position of the marker may be clearly perceived by the user.

### SUMMARY

The present disclosure has been devised in consideration of the above circumstances and provides a display control device, a display control method, a program product, and a non-transitory storage medium storing a display control program that may inhibit offset in the position of a marker relative to an object from being clearly perceived by a user.

A display control device pertaining to a first aspect includes a display control unit that causes a marker to be displayed in a display area of a display device in a position corresponding to an object included in a foreground of a vehicle visible through the display area of the display device or in an image resembling the foreground of the vehicle displayed in the display area of the display device, the marker comprising a plurality of partial images lined up next to and spaced apart from each other in a vehicle width direction and having sides along a lengthwise direction of the partial images that are not parallel to a vehicle vertical direction.

In the first aspect, the marker displayed in the position corresponding to the object included in the foreground of the vehicle or in the image resembling the foreground of the vehicle comprises the plural partial images lined up next to and spaced apart from each other in the vehicle width direction and has the sides along the lengthwise direction of the partial images that are not parallel to the vehicle vertical direction. Because of this, the vehicle width direction end portion sides of the marker have plural edges whose vehicle width direction positions are different. Additionally, the plural edges whose vehicle width direction positions are different are interpreted as reference points in the perception of the marker by the user, so the exact amount of offset in the position of the marker relative to the object is less likely to be perceived by the user. Furthermore, because the marker has a configuration in which the plural partial images are lined up next to and spaced apart from each other in the vehicle width direction, the vehicle width direction center portion of the marker for example is less likely to be interpreted as a reference point in the perception of the marker by the user. Consequently, according to the first aspect, offset in the position of the marker relative to the object may be inhibited from being clearly perceived.

A display control device pertaining to a second aspect includes a display control unit that causes a marker to be displayed in a display area of a display device in a position corresponding to an object included in a foreground of a vehicle visible through the display area of the display device or in an image resembling the foreground of the vehicle displayed in the display area of the display device, the marker having a polygonal shape with short sides that are positioned on vehicle width direction end portion sides of the marker and are not parallel to a vehicle vertical direction.

In the second aspect, the marker displayed in the position corresponding to the object included in the foreground of the vehicle or in the image resembling the foreground of the vehicle has a polygonal shape with short sides that are positioned on vehicle width direction end portion sides of the marker and are not parallel to the vehicle vertical direction. Because of this, like the marker pertaining to the first aspect, the vehicle width direction end portion sides of the marker have plural edges whose vehicle width direction positions are different. Additionally, the plural edges whose vehicle width direction positions are different are interpreted as reference points in the perception of the marker by the user, so the exact amount of offset in the position of the marker relative to the object is less likely to be perceived by the user. Consequently, according to the second aspect, as in the first aspect, offset in the position of the marker relative to the object may be inhibited from being clearly perceived. It will be noted that in the first aspect and the second aspect, the position corresponding to the object may be a position superimposed on the object, a position adjacent to the object, or a position spaced less than a predetermined value from the object.

A third aspect is the first aspect, wherein the partial images are arranged at an even spacing in the vehicle width direction.

In a case in which there are differences in the density of the arrangement of the partial images, the plural partial images corresponding to a part where the spacing is small (a part where the arrangement is dense) are more likely to be perceived as a single image in the perception of the marker by the user. Additionally, a vehicle width direction end portion or center portion of the partial images perceived as a single image is more likely to be interpreted as a reference point in the perception of the marker by the user. In contrast, in the third aspect, the partial images are arranged at an even spacing in the vehicle width direction. Therefore, compared with a case in which there are differences in the density of the arrangement of the partial images, offset in the position of the marker relative to the object may be more effectively inhibited from being clearly perceived.

A fourth aspect is the first aspect, wherein the partial images each have a shape where one of a vehicle vertical direction upper end portion and lower end portion of the partial image is parallel to the vehicle width direction while the other is parallel to the vehicle vertical direction.

In the fourth aspect, the portions among the vehicle vertical direction upper end portions and lower end portions that are parallel to the vehicle width direction are less likely to be interpreted as reference points with respect to offset in the vehicle width direction position in the perception of the marker by the user. Furthermore, the portions among the upper end portions and the lower end portions that are parallel to the vehicle vertical direction are less likely to be interpreted as reference points with respect to offset in the vehicle vertical direction position in the perception of the marker by the user. Because of this, offset in the position of the marker in the vehicle width direction and the vehicle vertical direction relative to the object may be inhibited from being clearly perceived.

It will be noted that “parallel” in the fourth aspect also includes a state in which, relative to “geometrically parallel,” there is an angular difference of a predetermined value or less that is perceived as parallel in the perception of the marker by the user.

A fifth aspect is the first aspect or the second aspect, wherein the marker is bilaterally asymmetrical in the vehicle width direction.

In a case in which the marker is bilaterally asymmetrical in the vehicle width direction, the vehicle width direction center portion of the marker for example is less likely to be interpreted as a reference point in the perception of the marker by the user compared with a case in which the marker is bilaterally symmetrical in the vehicle width direction. Consequently, according to the fifth aspect, offset in the position of the marker relative to the object may be further inhibited from being clearly perceived.

A sixth aspect is the first aspect or the second aspect, wherein the display control unit acquires a confidence value associated with perception of the position of the object and changes the display mode of the marker based on the acquired confidence value.

In the sixth aspect, the display control unit changes the display mode of the marker based on the confidence value associated with perception of the position of the object. Therefore, the user may be made aware of the confidence value associated with perception of the position of the object.

A seventh aspect is the sixth aspect, wherein the display control unit acquires a vehicle vertical direction confidence value associated with perception of the position of the object and changes the display mode of the marker by changing the vehicle vertical direction width of the marker based on the acquired vehicle vertical direction confidence value.

According to the seventh aspect, a simple change to the display mode in which the vehicle vertical direction width of the marker is changed may make the user aware of the vehicle vertical direction confidence value associated with perception of the position of the object.

An eighth aspect is the seventh aspect, wherein the display control unit increases the vehicle vertical direction width of the marker as the acquired vehicle vertical direction confidence value becomes lower.

According to the eighth aspect, the user may be made intuitively aware of the vehicle vertical direction confidence value associated with perception of the position of the object. Furthermore, by increasing the vehicle vertical direction width of the marker as the vehicle vertical direction confidence value associated with perception of the position of the object becomes lower, offset in the position of the marker relative to the object may be inhibited from being clearly perceived in a case in which the vehicle vertical direction confidence value associated with perception of the position of the object is low.

A ninth aspect is the sixth aspect, wherein the display control unit acquires a vehicle width direction confidence value associated with perception of the position of the object and changes the display mode of the marker by changing shades of color of the marker in the vehicle width direction based on the acquired vehicle width direction confidence value.

According to the ninth aspect, a simple change to the display mode in which shades of color of the marker are changed in the vehicle width direction may make the user aware of the vehicle width direction confidence value associated with perception of the position of the object.

A tenth aspect is the ninth aspect, wherein the display control unit lengthens the length, along the vehicle width direction, of light-colored portions of the marker such that the color is light as the acquired vehicle width direction confidence value becomes lower.

According to the tenth aspect, the user may be made intuitively aware of the vehicle width direction confidence value associated with perception of the position of the object.

An eleventh aspect is the first aspect, wherein the marker comprises a plurality of partial images arranged a spacing apart from each other in the vehicle width direction, and the display control unit reduces an image of the marker as the distance between the vehicle and the object increases and causes the marker to be displayed in the display area of the display device, and adjusts the spacing between the partial images along the vehicle width direction and the number of the partial images so that the spacing, along the vehicle width direction, between the partial images in the reduced image of the marker becomes greater than the resolution of the eye.

In the eleventh aspect, the display control unit reduces the image of the marker as the distance between the vehicle and the object increases and causes it to be displayed in the display area of the display device. Because of this, the spacing between the partial images becomes smaller as the distance between the vehicle and the object increases, so the entire marker is more likely to be perceived as a single image in the perception of the marker by the user. To address this, in the eleventh aspect, the display control unit adjusts the spacing between the partial images along the vehicle width direction and the number of the partial images so that the spacing, along the vehicle width direction, between the partial images in the reduced image of the marker becomes greater than the resolution of the eye, so the entire marker is inhibited from being perceived as a single image. Consequently, according to the eleventh aspect, offset in the position of the marker relative to the object may be inhibited from being clearly perceived even in a case in which the distance between the vehicle and the object is large.

A twelfth aspect is the first aspect or the second aspect, wherein the display device is a head-up display.

According to the twelfth aspect, offset in the position of the marker relative to the object may be inhibited from being clearly perceived when displaying the marker in a display area of a head-up display.

A display control method pertaining to a thirteenth aspect causes a computer to execute a process including causing a marker to be displayed in a display area of a display device in a position corresponding to an object included in a foreground of a vehicle visible through the display area of the display device or in an image resembling the foreground of the vehicle displayed in the display area of the display device, the marker comprising a plurality of partial images lined up next to and spaced apart from each other in a vehicle width direction and having sides along a lengthwise direction of the partial images that are not parallel to a vehicle vertical direction.

According to the thirteenth aspect, as in the first aspect, offset in the position of the marker relative to the object may be inhibited from being clearly perceived.

A display control method pertaining to a fourteenth aspect causes a computer to execute a process including causing a marker to be displayed in a display area of a display device in a position corresponding to an object included in a foreground of a vehicle visible through the display area of the display device or in an image resembling the foreground of the vehicle displayed in the display area of the display device, the marker having a polygonal shape with short sides that are positioned on vehicle width direction end portion sides of the marker and are not parallel to a vehicle vertical direction.

According to the fourteenth aspect, as in the second aspect, offset in the position of the marker relative to the object may be inhibited from being clearly perceived.

A fifteenth aspect is a non-transitory storage medium storing a program that causes a computer to execute display control processing, the display control processing including causing a marker to be displayed in a display area of a display device in a position corresponding to an object included in a foreground of a vehicle visible through the display area of the display device or in an image resembling the foreground of the vehicle displayed in the display area of the display device, the marker comprising a plurality of partial images lined up next to and spaced apart from each other in a vehicle width direction and having sides along a lengthwise direction of the partial images that are not parallel to a vehicle vertical direction.

According to the fifteenth aspect, as in the first aspect, offset in the position of the marker relative to the object may be inhibited from being clearly perceived.

A sixteenth aspect is a non-transitory storage medium storing a program that causes a computer to execute display control processing, the display control processing including causing a marker to be displayed in a display area of a display device in a position corresponding to an object included in a foreground of a vehicle visible through the display area of the display device or in an image resembling the foreground of the vehicle displayed in the display area of the display device, the marker having a polygonal shape with short sides that are positioned on vehicle width direction end portion sides of the marker and are not parallel to a vehicle vertical direction.

According to the sixteenth aspect, as in the second aspect, offset in the position of the marker relative to the object may be inhibited from being clearly perceived.

A seventeenth aspect is a program product comprising a program that causes a computer to execute display control processing, the display control processing including causing a marker to be displayed in a display area of a display device in a position corresponding to an object included in a foreground of a vehicle visible through the display area of the display device or in an image resembling the foreground of the vehicle displayed in the display area of the display device, the marker comprising a plurality of partial images lined up next to and spaced apart from each other in a vehicle width direction and having sides along a lengthwise direction of the partial images that are not parallel to a vehicle vertical direction.

An eighteenth aspect is a program product comprising a program that causes a computer to execute display control processing, the display control processing including causing a marker to be displayed in a display area of a display device in a position corresponding to an object included in a foreground of a vehicle visible through the display area of the display device or in an image resembling the foreground of the vehicle displayed in the display area of the display device, the marker having a polygonal shape with short sides that are positioned on vehicle width direction end portion sides of the marker and are not parallel to a vehicle vertical direction.

According to the present disclosure, offset in the position of the marker relative to the object may be inhibited from being clearly perceived by the user.

### BRIEF DESCRIPTION OF THE DRAWINGS

Examples of embodiments of the present disclosure will be described in detail below with reference to the following drawings, wherein:

FIG. 1 is a block diagram illustrating the schematic configuration of an in-vehicle system pertaining to embodiments;

FIG. 2 is a functional block diagram of a camera unit and a display control ECU;

FIG. 3 is an explanatory diagram illustrating the schematic configuration of an AR-HUD;

FIG. 4 is a drawing illustrating a marker pertaining to a first embodiment;

FIG. 5 is a flowchart illustrating a display control process pertaining to the first embodiment;

FIG. 6A is an illustration showing a state in which the marker is being displayed in an appropriate position relative to a preceding vehicle;

FIG. 6B is an illustration showing a state in which the marker is being displayed offset to the right relative to the preceding vehicle;

FIG. 6C is an illustration showing a state in which the marker is being displayed offset to the left relative to the preceding vehicle;

FIG. 7A is an illustration showing a state in which the marker is being displayed offset upward relative to the preceding vehicle;

FIG. 7B is an illustration showing a state in which the marker is being displayed offset downward relative to the preceding vehicle;

FIG. 8 is a flowchart illustrating a display control process pertaining to a second embodiment;

FIG. 9A is an illustration showing an aspect in which the vehicle vertical direction length of the marker is changed in accordance with a vehicle vertical direction confidence value;

FIG. 9B is an illustration showing the aspect in which the vehicle vertical direction length of the marker is changed in accordance with the vehicle vertical direction confidence value;

FIG. 10A is an illustration showing the aspect in which the vehicle vertical direction length of the marker is changed in accordance with the vehicle vertical direction confidence value;

FIG. 10B is an illustration showing the aspect in which the vehicle vertical direction length of the marker is changed in accordance with the vehicle vertical direction confidence value;

FIG. 11A is an illustration showing an aspect in which the ratio of dark-colored portions of the marker is changed in accordance with a vehicle width direction confidence value;

FIG. 11B is an illustration showing the aspect in which the ratio of the dark-colored portions of the marker is changed in accordance with the vehicle width direction confidence value;

FIG. 11C is an illustration showing the aspect in which the ratio of the dark-colored portions of the marker is changed in accordance with the vehicle width direction confidence value;

FIG. 12A is an illustration showing the aspect in which the ratio of the dark-colored portions of the marker is changed in accordance with the vehicle width direction confidence value;

FIG. 12B is an illustration showing the aspect in which the ratio of the dark-colored portions of the marker is changed in accordance with the vehicle width direction confidence value;

FIG. 12C is an illustration showing the aspect in which the ratio of the dark-colored portions of the marker is changed in accordance with the vehicle width direction confidence value;

FIG. 13 is a flowchart illustrating a display control process pertaining to a third embodiment;

FIG. 14A is an illustration showing an example of displays of the marker in a near-distance display and a far-distance display;

FIG. 14B is a diagram illustrating an example where the number of and spacing between partial images of the marker are changed in accordance with the distance to the preceding vehicle;

FIG. 14C is an explanatory diagram describing differences in the display of the marker between a case in which the number of and spacing between the partial images are not changed in the far-distance display and a case in which the number of and spacing between the partial images are changed in the far-distance display;

FIG. 15 is an illustration showing an example of a variation of the marker pertaining to the present disclosure;

FIG. 16 is an illustration showing an example of a variation of the marker pertaining to the present disclosure;

FIG. 17 is an illustration showing an example of a variation of the marker pertaining to the present disclosure;

FIG. 18 is an illustration showing an example of a variation of the marker pertaining to the present disclosure;

FIG. 19 is an illustration showing an example of a variation of the marker pertaining to the present disclosure;

FIG. 20 is an illustration showing an example of a variation of the marker pertaining to the present disclosure;

FIG. 21 is an illustration showing an example of a variation of the marker pertaining to the present disclosure;

FIG. 22 is an illustration showing an example of a variation of the marker pertaining to the present disclosure;

FIG. 23 is an illustration showing an example of a variation of the marker pertaining to the present disclosure; and

FIG. 24 is an illustration showing an example of a variation of the marker pertaining to the present disclosure.

### DETAILED DESCRIPTION

### First Embodiment

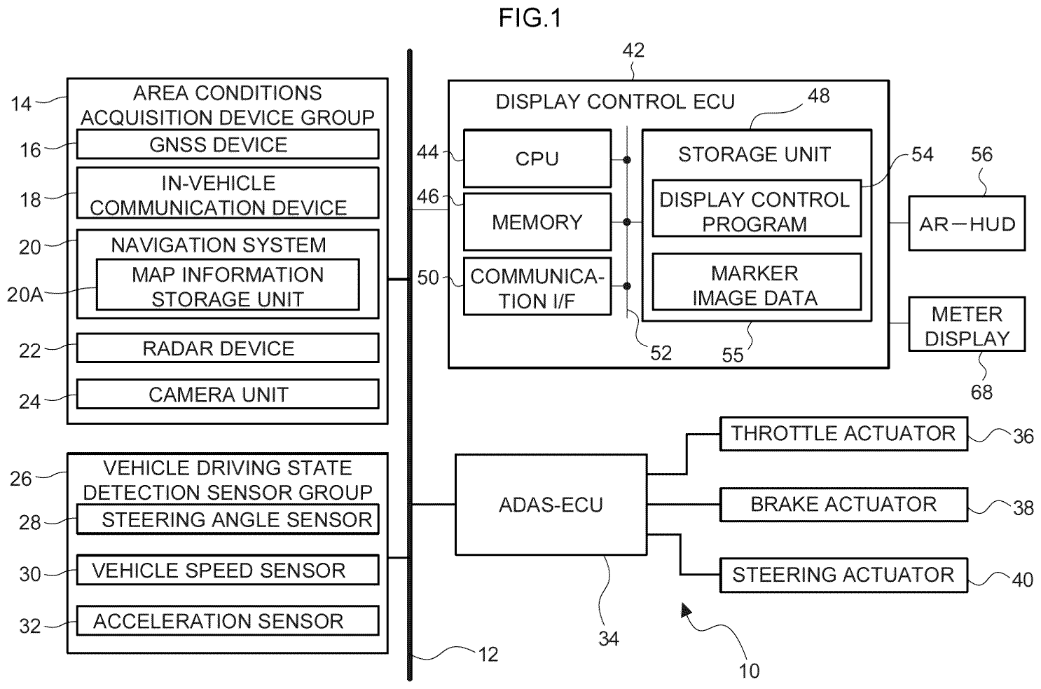

As illustrated in FIG. 1, an in-vehicle system 10 pertaining to the present embodiment includes a communication bus 12, and connected to the communication bus 12 are an area conditions acquisition device group 14, a vehicle driving state detection sensor group 26, an advanced driver-assistance system (ADAS) electronic control unit (ECU) 34, and a display control ECU 42. It will be noted that FIG. 1 illustrates only part of the in-vehicle system 10. Furthermore, the vehicle in which the in-vehicle system 10 is installed is hereinafter referred to as the host vehicle.

The area conditions acquisition device group 14 includes, as devices that acquire information indicating environmental conditions in the area around the host vehicle, a global navigation satellite system (GNSS) device 16, an in-vehicle communication device 18, a navigation system 20, a radar device 22, and a camera unit 24.

The GNSS device 16 receives GNSS signals from multiple GNSS satellites to locate the position of the host vehicle. The in-vehicle communication device 18 performs at least one of vehicle-to-vehicle communication with other vehicles and vehicle-to-roadside communication with roadside units. The navigation system 20 includes a map information storage unit 20A that stores map information, and the navigation system 20 performs a process to display the host vehicle's position on a map and determine the route and provide directions to the host vehicle's destination based on the position information obtained from the GNSS device 16 and the map information stored in the map information storage unit 20A.

The radar device 22 detects objects such as pedestrians and other vehicles in the area around the host vehicle as point group information to acquire the relative position and relative velocity of the host vehicle with respect to the detected objects. Furthermore, the radar device 22 excludes noise and roadside objects such as guardrails from its monitored targets based for example on changes in relative position and relative velocity with respect to the individual objects and outputs information such as relative position and relative velocity with respect to monitored targets such as pedestrians and other vehicles.

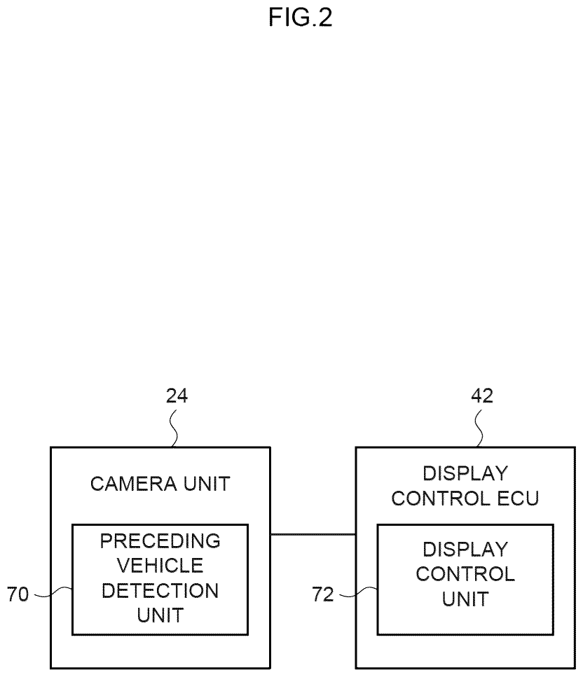

The camera unit 24 captures with multiple cameras images of the area around the host vehicle and outputs the captured images. Although not shown in the drawings, the camera unit 24 has a built-in central processing unit (CPU), memory such as a read-only memory (ROM) or a random-access memory (RAM), and non-volatile storage unit such as a hard disk drive (HDD) or a solid-state drive (SSD). The storage unit storage a predetermined program for causing the CPU of the camera unit 24 to function as a preceding vehicle detection unit 70 (see FIG. 2). The preceding vehicle detection unit 70 perceives, based on images of what is in front of the host vehicle obtained by the multiple cameras, a preceding vehicle in front of the host vehicle appearing in the images and detects and outputs the distance between and relative positions in the vehicle width direction of the host vehicle and the preceding vehicle.

Furthermore, the vehicle driving state detection sensor group 26 includes, as multiple sensors that acquire information about the driving state of the host vehicle, a steering angle sensor 28 that detects the steering angle of the host vehicle, a vehicle speed sensor 30 that detects the driving speed of the host vehicle, and an acceleration sensor 32 that detects acceleration acting on the host vehicle.

Connected to the ADAS-ECU 34 are a throttle actuator 36 that changes the throttle position of the host vehicle, a brake actuator 38 that changes the braking force generated by the braking system of the host vehicle, and a steering actuator 40 that changes the amount of steering by the steering system of the host vehicle.

The ADAS-ECU 34 includes a CPU, a memory such as a ROM or a RAM, a non-volatile storage unit such as an HDD or an SSD, and a communication interface (I/F). The storage unit stores ADAS software. In a case in which an autonomous driving mode is selected as a result of the CPU executing autonomous driving software, the ADAS-ECU 34 performs an autonomous driving process that allows the host vehicle to drive autonomously without driving input from the occupant of the host vehicle.

The autonomous driving process is a process that determines the conditions of the host vehicle and the area around the host vehicle, and controls the throttle actuator 36, the brake actuator 38, and the steering actuator 40 based on the information obtained from the area conditions acquisition device group 14 and the vehicle driving state detection sensor group 26. An example of the autonomous driving process is adaptive cruise control (ACC), which drives the host vehicle so as to follow the preceding vehicle perceived by the camera unit 24.

The display control ECU 42 includes a CPU 44, a memory 46 such as a ROM or a RAM, a non-volatile storage unit 48 such as an HDD or an SSD, and a communication interface (I/F) 50. The CPU 44, the memory 46, the storage unit 48, and the communication interface 50 are communicably connected to each other via an internal bus 52. The storage unit 48 stores a display control program 54 and marker image data 55. The display control ECU 42 functions as a display control unit 72 shown in FIG. 2 and performs a later-described display control process as a result of the display control program 54 being read from the storage unit 48 and loaded to the memory 46 and the display control program 54 that has been loaded to the memory 46 being executed by the CPU 44.

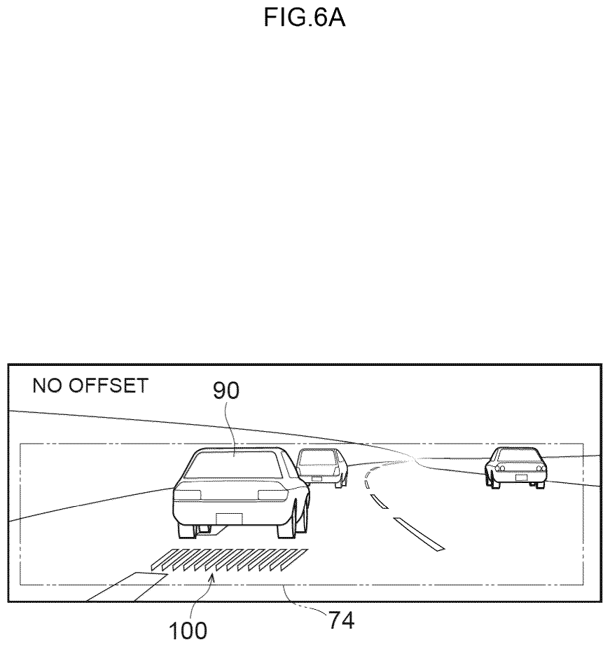

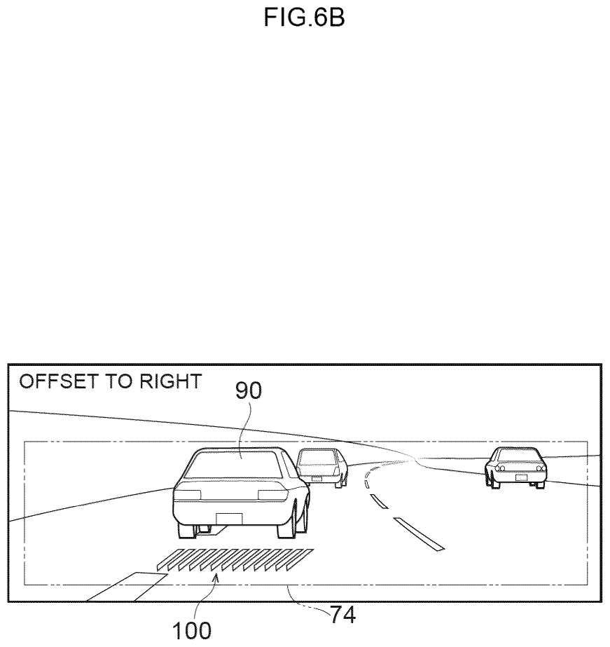

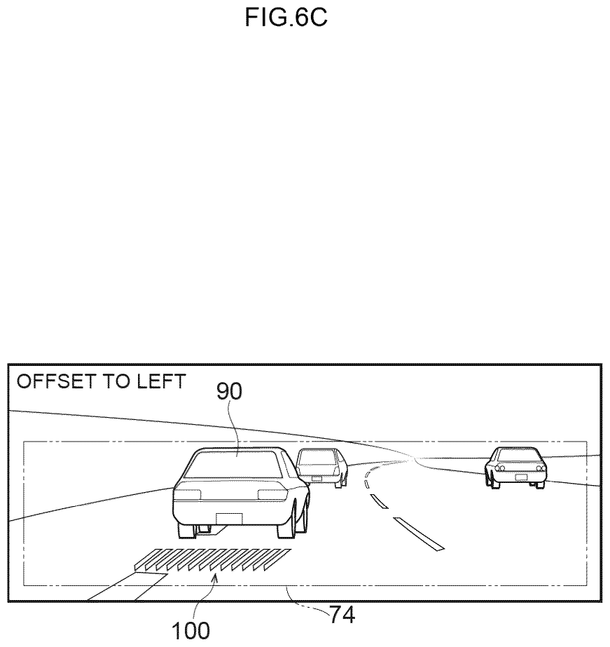

Connected to the display control ECU 42 are an augmented reality (AR) head-up display (hereinafter “AR-HUD”) 56 and a meter display 68. The AR-HUD 56 pertaining to the present embodiment is, as shown in FIG. 6A and other drawings where reference sign 74 denotes a display area, a small HUD that uses part of the forward field of view of the user who is an occupant of the host vehicle as the display area 74 (forms an image in the lower foreground) by for example reflection on the windshield glass. Furthermore, the meter display 68 is a display provided in the instrument panel of the host vehicle. The display control ECU 42 controls the display of information on the AR-HUD 56 and the meter display 68.

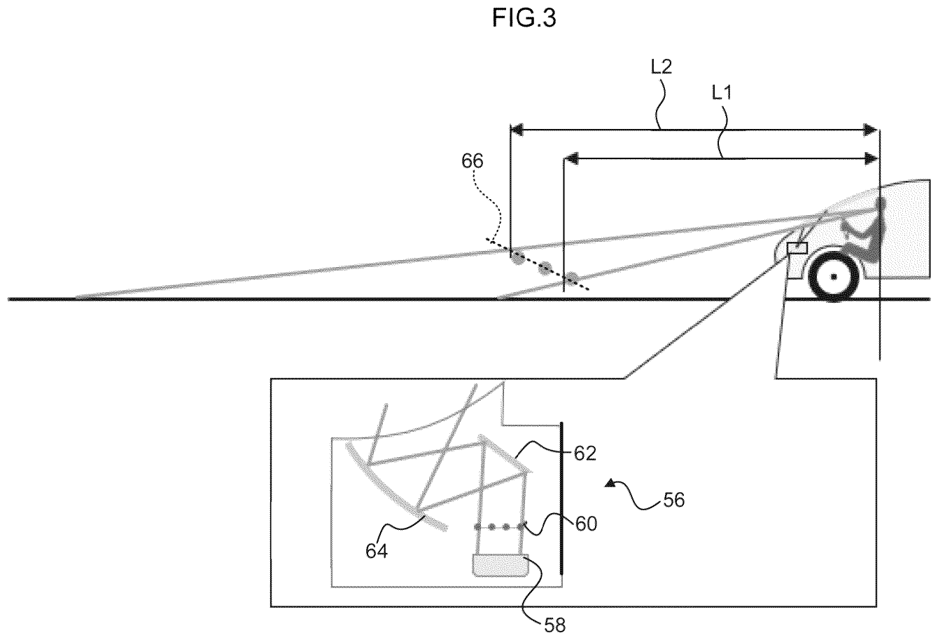

As illustrated in FIG. 3, the AR-HUD 56 includes a light source unit 58 including a light emitting diode (LED) for example, and a transmissive display unit 60 including a liquid crystal display (LCD) for example is disposed on the light exiting side of the light source unit 58. A convex mirror 62 and a concave mirror 64 are disposed in this order on the light exiting side of the display unit 60, and light that has passed through the display unit 60 is reflected in the order of the convex mirror 62 and the concave mirror 64 and applied to the windshield of the host vehicle. The optical system of the AR-HUD 56 is designed so that an image (a later-described marker 100 etc.) displayed by the display unit 60 is formed on a virtual image plane 66 inclined relative to the vehicle vertical direction and floating in the air a distance L1 to L2 from the user. This may create for the user the illusion that the image formed on the virtual image plane 66 is superimposed on the road surface in front of the host vehicle.

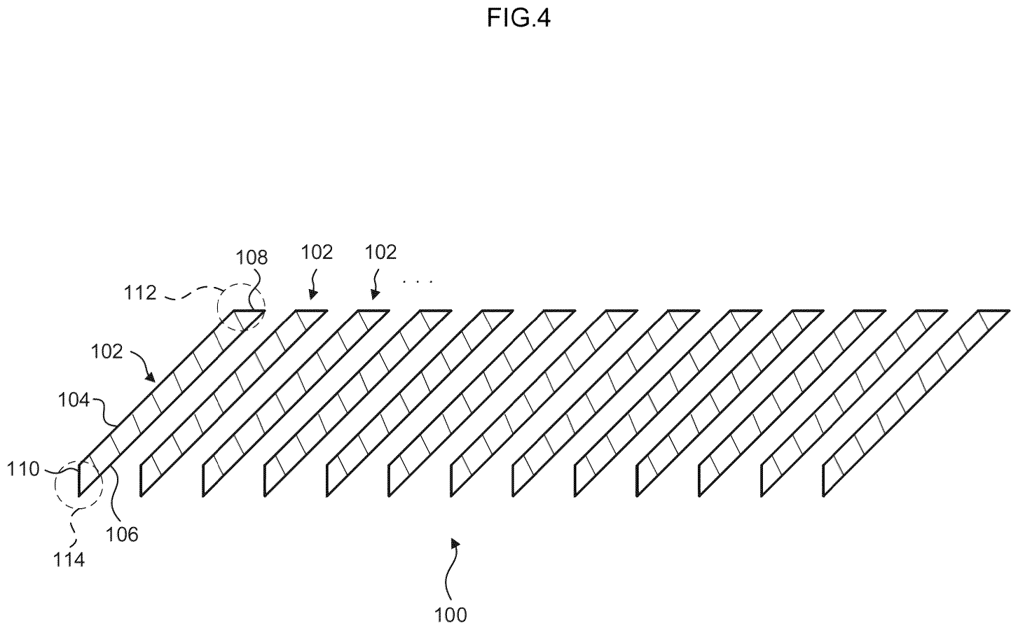

Furthermore, the marker image data 55 stored in the storage unit 48 of the display control ECU 42 are data representing a marker 100 shown in FIG. 4. The marker 100 pertaining to the present embodiment has widths in the vehicle vertical direction and the vehicle width direction, and the outer shapes of its vehicle width direction outer edges are not parallel to the vehicle vertical direction. More specifically, the marker 100 is configured by plural partial images 102 that have the same shape and are arranged at an even spacing in the vehicle width direction, and each of the individual partial images 102 is roughly trapezoidal. That is, each of the individual partial images 102 has a pair of parallel sides 104, 106 comprising straight lines that are inclined relative to the vehicle vertical direction and the vehicle width direction. Furthermore, in each of the individual partial images 102, upper end portions in the vehicle vertical direction of the sides 104, 106 are interconnected by a side 108 that is parallel to the vehicle width direction, and lower end portions in the vehicle vertical direction of the sides 104, 106 are interconnected by a side 110 that is parallel to the vehicle vertical direction. Additionally, the positions in the vehicle vertical direction of the sides 108, 110 of the plural partial images 102 of the marker 100 are aligned.

It will be noted that the display control ECU 42 is an example of a display control device and a display control unit. Furthermore, the HUD 56 is an example of a display device. Furthermore, the marker 100 is an example of “a marker comprising a plurality of partial images lined up next to and spaced apart from each other in a vehicle width direction and having sides along a lengthwise direction of the partial images that are not parallel to a vehicle vertical direction.”

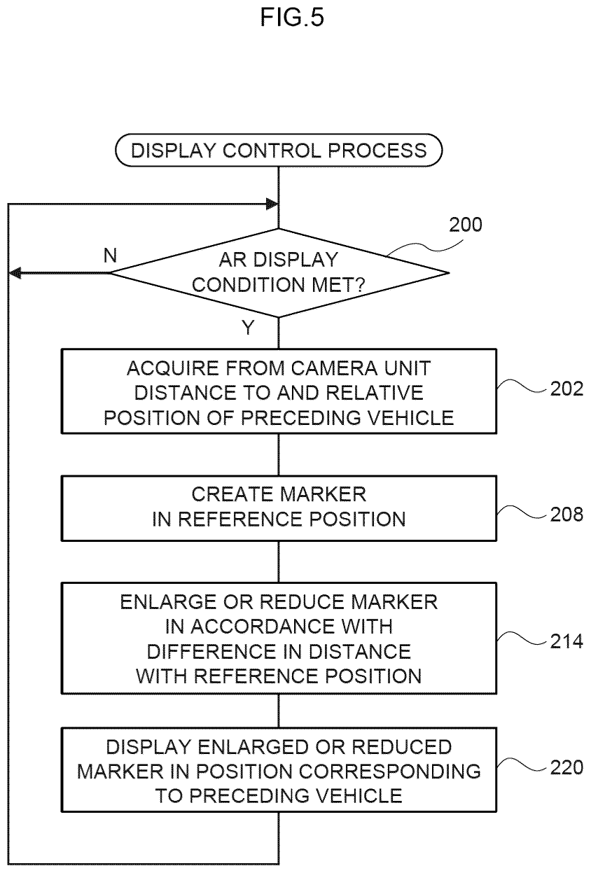

Next, as the operation of the first embodiment, a display control process executed by the display control ECU 42 (or the display control unit 72) while the ignition switch of the host vehicle is on will be described with reference to FIG. 5.

In step 200 of the display control process, the display control unit 72 determines whether an AR display condition is met. In the present embodiment, the display control unit 72 determines that the AR display condition is met in a case in which the ADAS-ECU 34 is executing ACC. In a case in which the ADAS-ECU 34 is not executing ACC, the determination of step 200 becomes NO and the display control unit 72 repeats the determination of step 200. In this case, the marker 100 is not displayed in the display area 74 of the AR-HUD 56.

Furthermore, in a case in which the ADAS-ECU 34 is executing ACC, the determination of step 200 becomes YES and the determination control unit 72 moves to step 202. In step 202, the display control unit 72 acquires from the camera unit 24 the distance to a preceding vehicle and relative position in the vehicle width direction of the preceding vehicle that the host vehicle is following by ACC by the ADAS-ECU 34.

Furthermore, in step 208, the display control unit 72 reads the marker image data 55 from the storage unit 48 and, based on the marker image data 55 it has read, creates the marker 100 which is to be displayed in the display area 74 of the AR-HUD 56 in a case in which the preceding vehicle is positioned in a reference position in which the distance to the preceding vehicle is a predetermined reference distance.

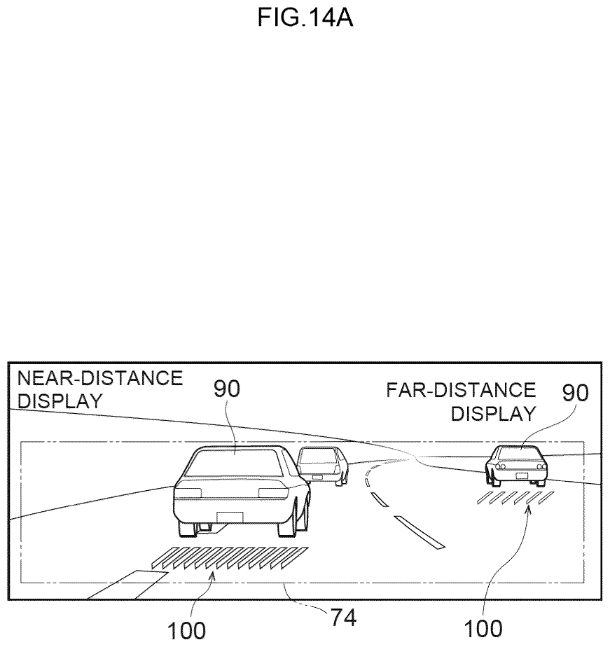

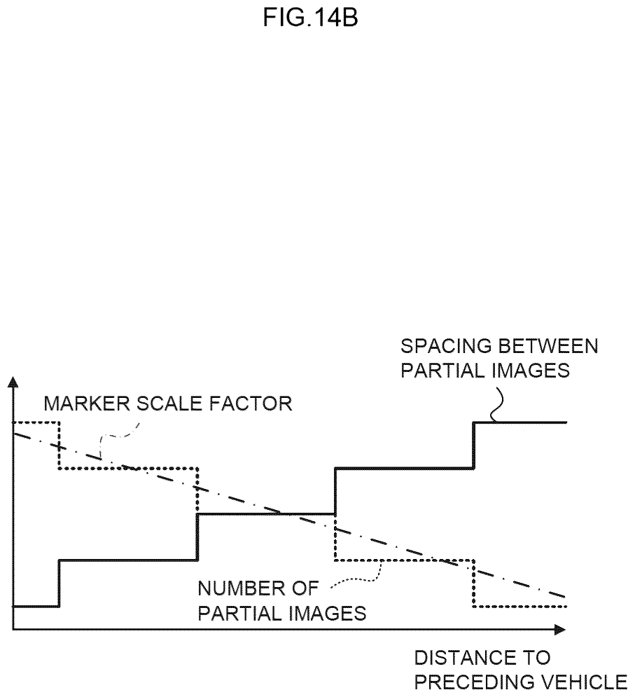

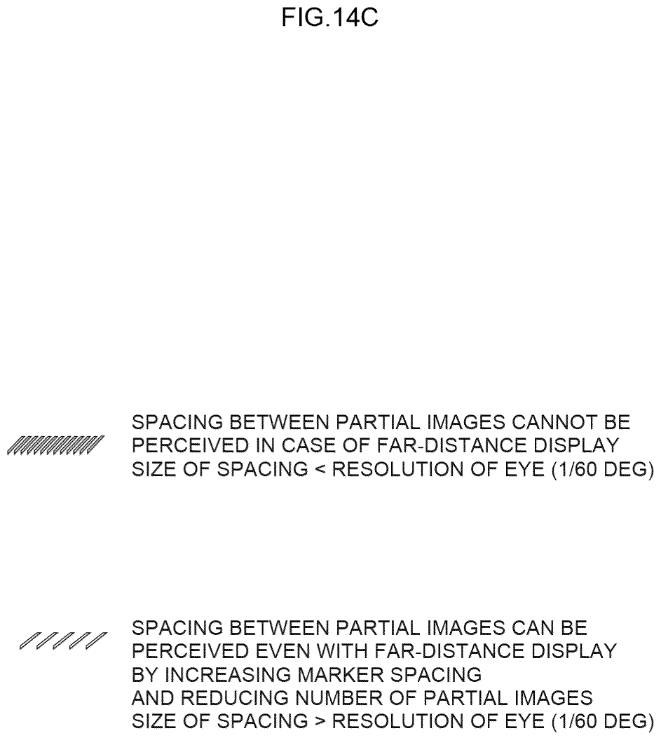

In the next step 214, the display control unit 72 enlarges or reduces the marker 100 in accordance with the difference in distance between the distance to the preceding vehicle acquired in step 202 and the aforementioned reference distance. It will be noted that the scale factor of the marker 100 is decided in such a way that, as illustrated in FIG. 14B as an example, the scale factor becomes smaller (i.e., changes toward being reduced) as the distance to the preceding vehicle increases.

In step 220, the display control unit 72 calculates the display position of the marker 100 on the AR-HUD 56 to cause the marker 100 to be displayed in a position corresponding to an image 90 of the preceding vehicle inside the display area 74 (e.g., see FIG. 6A) based on the distance to and relative position in the vehicle width direction of the preceding vehicle. Additionally, the display control unit 72 controls the AR-HUD 56 so that the enlarged or reduced marker 100 is displayed in a position corresponding to the image 90 of the preceding vehicle. After the process of step 220 ends, the display control unit 72 returns to step 200.

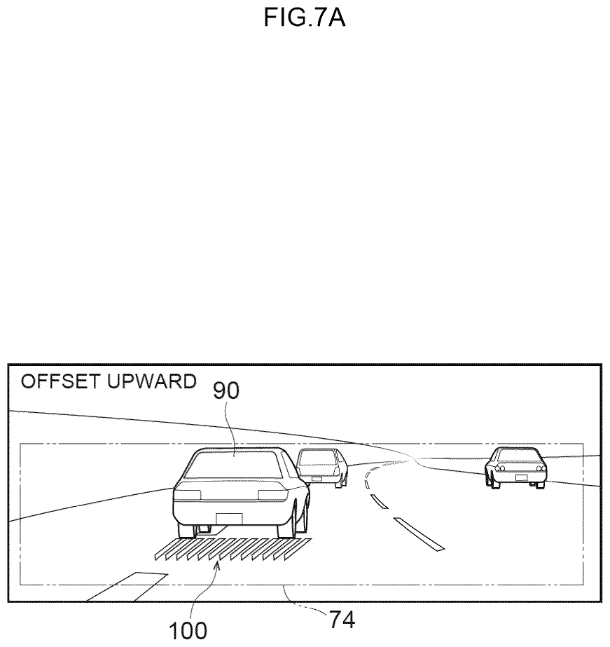

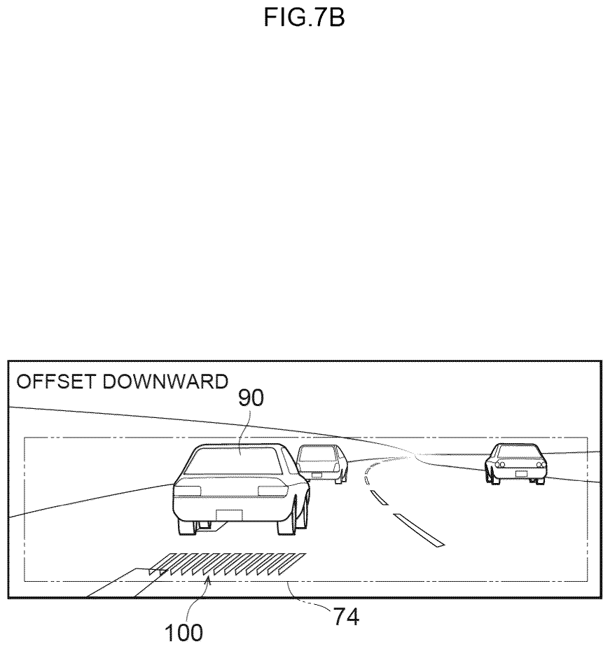

Because of the above display control process, the marker 100 is displayed in a position corresponding to the image 90 of the preceding vehicle inside the display area 74 of the AR-HUD 56 (e.g., see FIG. 6A) while the ADAS-ECU 34 is executing ACC. However, the precision with which the camera unit 24 detects the position of the preceding vehicle fluctuates due, for example, to the color of the preceding vehicle, the distance to the preceding vehicle, and the weather. For this reason, as illustrated in FIG. 6B, FIG. 6C, FIG. 7A, and FIG. 7B for example, the marker 100 may be displayed in a position that is offset relative to the image 90 of the preceding vehicle.

FIG. 6B illustrates a state (offset to the right) in which the marker 100 is displayed in a position offset to the right side in the vehicle width direction relative to the proper display position of the marker 100 shown in FIG. 6A. FIG. 6C illustrates a state (offset to the left) in which the marker 100 is displayed in a position offset to the left side in the vehicle width direction relative to the proper display position of the marker 100 shown in FIG. 6A. FIG. 7A illustrates a state (offset upward) in which the marker 100 is displayed in a position offset upward in the vehicle vertical direction relative to the proper display position of the marker 100 shown in FIG. 6A. FIG. 7B illustrates a state (offset downward) in which the marker 100 is displayed in a position offset downward in the vehicle vertical direction relative to the proper display position of the marker 100 shown in FIG. 6A.

To address this, the marker 100 pertaining to the present embodiment, as shown in FIG. 4, has widths in the vehicle vertical direction and the vehicle width direction, and the outer shapes of its vehicle width direction outer edges are not parallel to the vehicle vertical direction. Furthermore, the marker 100 is configured by plural partial images 102 that have the same shape and are arranged at an even spacing in the vehicle width direction, and each of the individual partial images 102 is roughly trapezoidal. That is, each of the individual partial images 102 has a pair of parallel sides 104, 106 comprising straight lines that are inclined relative to the vehicle vertical direction and the vehicle width direction. Furthermore, in each of the individual partial images 102, upper end portions in the vehicle vertical direction of the sides 104, 106 are interconnected by a side 108 that is parallel to the vehicle width direction, and lower end portions in the vehicle vertical direction of the sides 104, 106 are interconnected by a side 110 that is parallel to the vehicle vertical direction.

Because the marker 100 is configured to have the above-described shape, on the vehicle width direction left end of the marker 100 for example, the edge inside the range indicated by reference sign 112 and the edge inside the range indicated by reference sign 114 in FIG. 4 become interpreted as reference points in the perception of the marker by the user. Because of this, as is apparent also from FIG. 6B, FIG. 6C, FIG. 7A, and FIG. 7B, the exact amount of offset in the position of the marker 100 relative to the image 90 of the preceding vehicle is less likely to be perceived by the user. Consequently, offset in the position of the marker 100 relative to the image 90 of the preceding vehicle may be inhibited from being clearly perceived by the user.

As described above, in the present embodiment, the display control unit 72 causes the marker 100 comprising a plurality of partial images lined up next to and spaced apart from each other in a vehicle width direction and having sides along a lengthwise direction of the partial images that are not parallel to a vehicle vertical direction to be displayed in the display area 74 of the AR-HUD 56 in a position corresponding to an object included in the foreground of the vehicle through the display area 74 of the AR-HUD 56. Because of this, offset in the position of the marker 100 relative to the object may be inhibited from being clearly perceived.

Furthermore, in the first embodiment, the partial images 102 are arranged at an even spacing in the vehicle width direction, so compared with a case in which there are differences in the density of the arrangement of the partial images 102, offset in the position of the marker 100 relative to the object may be more effectively inhibited from being clearly perceived.

Moreover, in the first embodiment, the partial images 102 each have a shape where one of a vehicle vertical direction upper end portion and lower end portion of the partial image is parallel to the vehicle width direction while the other is parallel to the vehicle vertical direction. Therefore, offset in the position of the marker 100 in the vehicle width direction and the vehicle vertical direction relative to the object may be inhibited from being clearly perceived.

Furthermore, in the first embodiment, the marker 100 is bilaterally asymmetrical in the vehicle width direction and, therefore, offset in the position of the marker 100 relative to the object may be further inhibited from being clearly perceived.

### Second Embodiment

Next, a second embodiment of the present disclosure will be described. It will be noted that parts that are similar to those of the first embodiment are assigned the same reference signs, and description thereof will be omitted.

The camera unit 24 pertaining to the present embodiment detects the distance to and relative position in the vehicle width direction of the preceding vehicle and also detects, in regard to each of the vehicle vertical direction and the vehicle width direction, confidence values relating to the detection of the position of the preceding vehicle based on, for example, the color of the preceding vehicle, the distance to the preceding vehicle, and the weather.

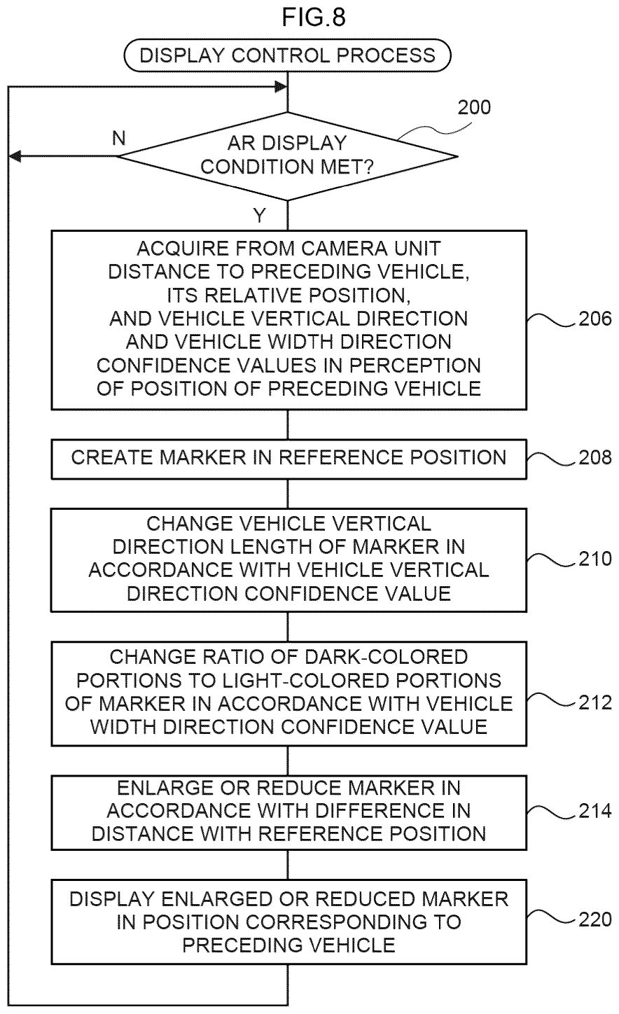

Next, the display control process pertaining to the second embodiment will be described with reference to FIG. 8. In the display control process pertaining to the second embodiment, after it is determined that the AR display condition is met and the determination of step 200 becomes YES, the display control unit 72 moves to step 206. In step 206, the display control unit 72 acquires from the camera unit 24 the distance to the preceding vehicle, its relative position in the vehicle width direction, and vehicle vertical direction and vehicle width direction confidence values in the perception of the position of the preceding vehicle.

In the next step 208, the display control unit 72 creates the marker 100 in the reference position. Then, in step S210, the display control unit 72 changes the display mode of the marker 100 created in step 208, specifically the vehicle vertical direction length of the marker 100, in accordance with the vehicle vertical direction confidence value in the perception of the position of the preceding vehicle.

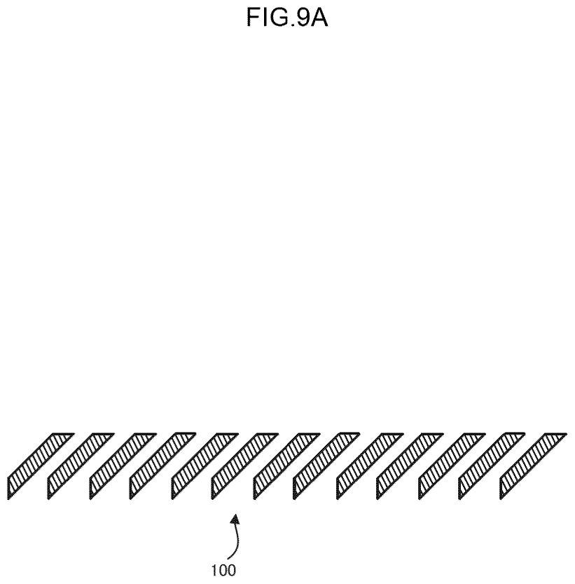

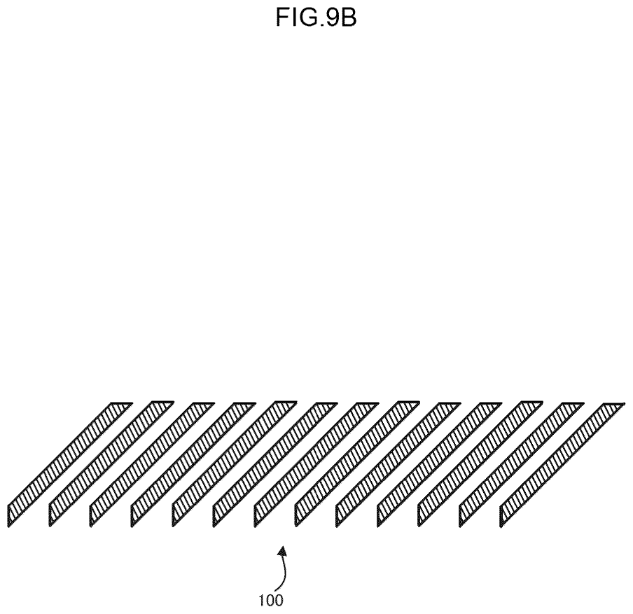

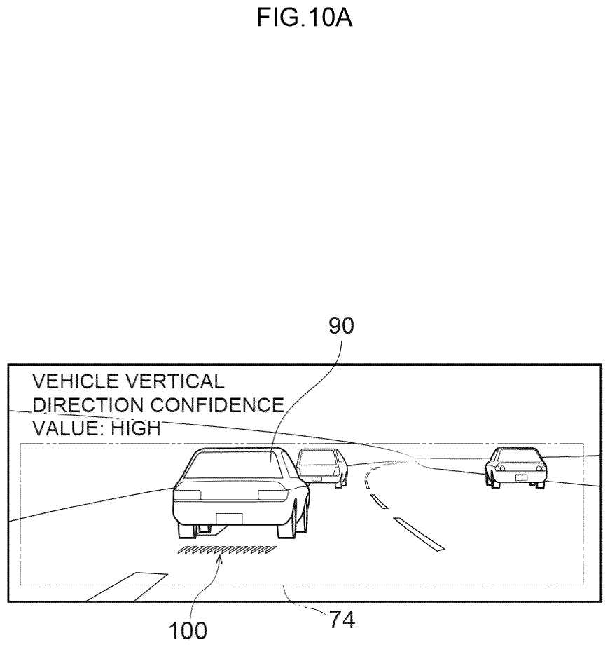

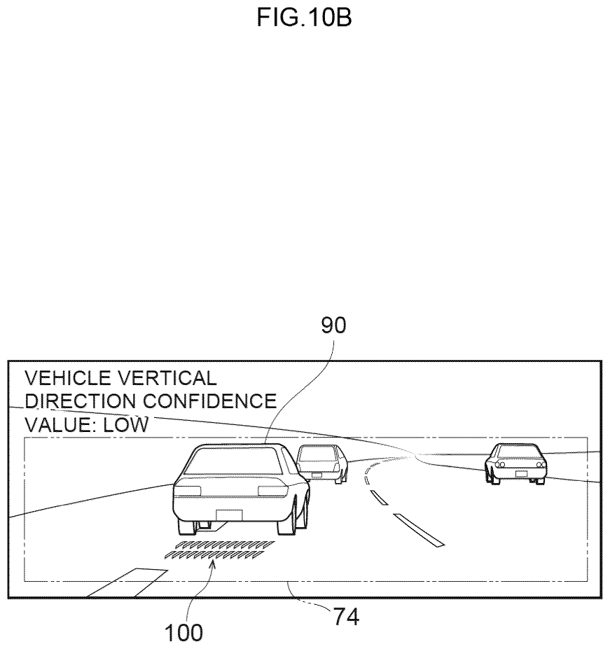

Specifically, in a case in which the vehicle vertical direction confidence value in the perception of the position of the preceding vehicle is equal to or greater than a threshold, the display control unit 72 relatively shortens the vehicle vertical direction length of the marker 100 as illustrated in FIG. 9A and FIG. 10A. In this case, the effect of inhibiting offset in the position of the marker 100 in regard to the vehicle vertical direction from being clearly perceived becomes smaller, and the vehicle vertical direction position becomes pinpointedly perceived because of the marker 100. In a case in which the vehicle vertical direction confidence value in the perception of the position of the preceding vehicle is less than the threshold, the display control unit 72 relatively lengthens the vehicle vertical direction length of the marker 100 as illustrated in FIG. 9B and FIG. 10B. In this case, the effect of inhibiting offset in the position of the marker 100 in regard to the vehicle vertical direction from being clearly perceived becomes greater. Additionally, by changing the vehicle vertical direction length of the marker 100 in accordance with the vehicle vertical direction confidence value in the perception of the position of the preceding vehicle as described above, the user may be made intuitively aware of the vehicle vertical direction confidence value associated with the perception of the position of the preceding vehicle.

Furthermore, in step 212, the display control unit 72 changes the display mode of the marker 100, specifically the ratio of dark-colored portions to light-colored portions of the marker 100 along the vehicle width direction, in accordance with the vehicle width direction confidence value in the perception of the position of the preceding vehicle acquired from the camera unit 24.

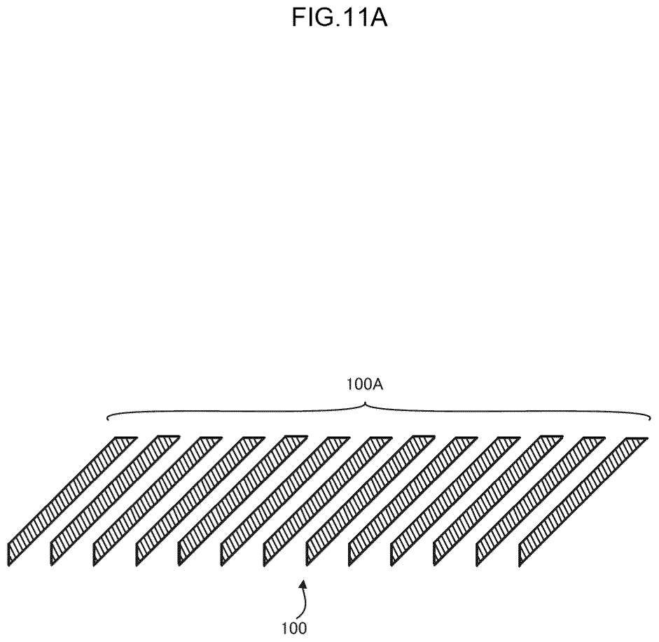

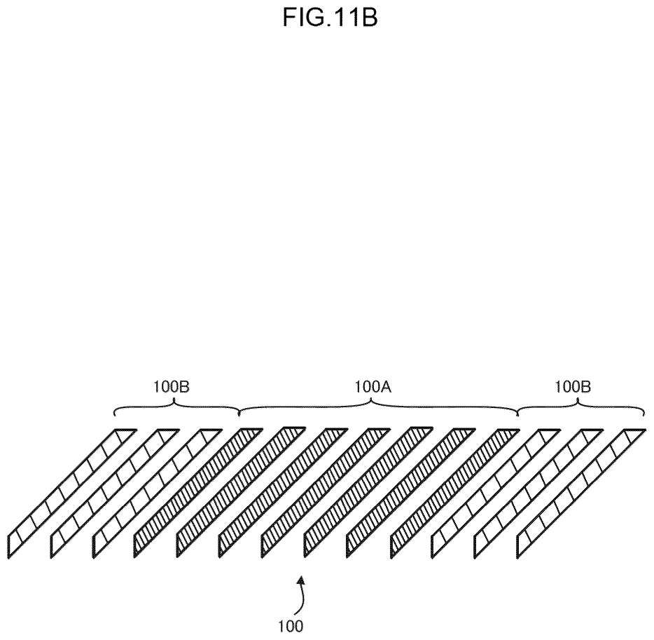

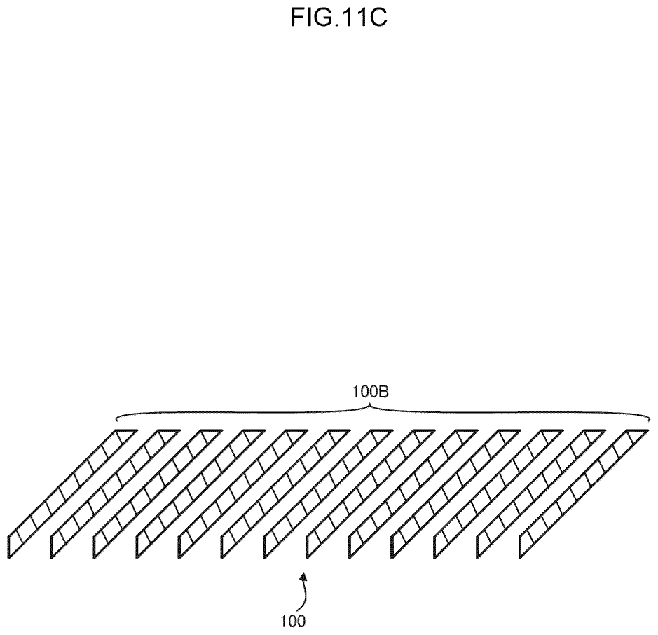

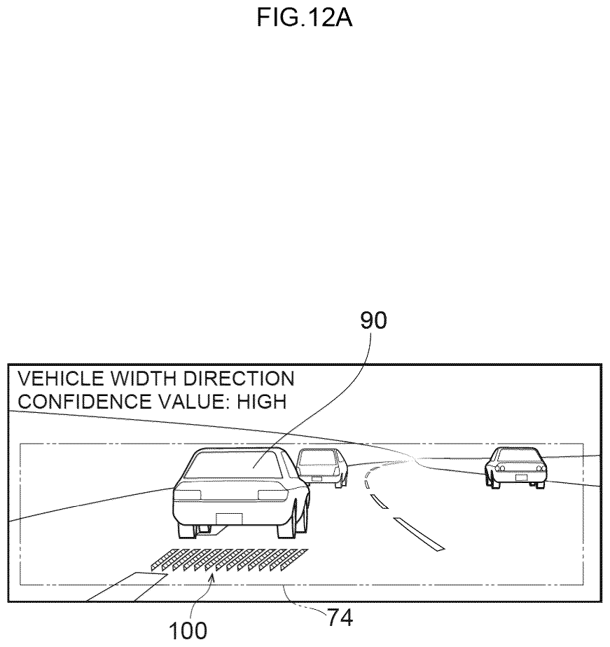

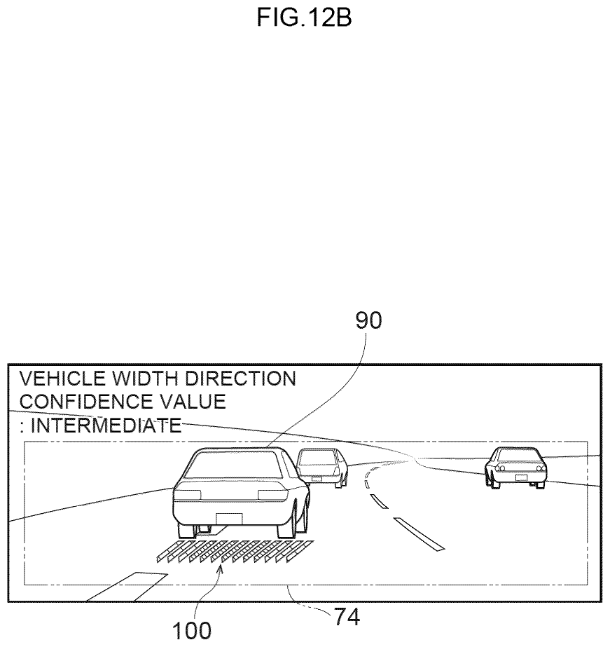

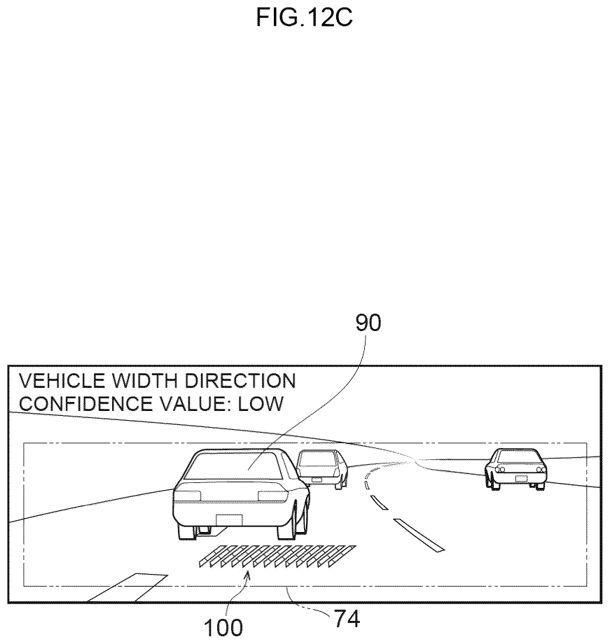

Specifically, in a case in which the vehicle width direction confidence value in the perception of the position of the preceding vehicle is equal to or greater than a first threshold, the display control unit 72 changes the ratio of dark-colored portions 100A of the marker 100 along the vehicle width direction to 100% as shown in FIG. 11A and FIG. 12A. Furthermore, in a case in which the vehicle width direction confidence value in the perception of the position of the preceding vehicle is less than the first threshold and equal to or greater than a second threshold (first threshold>second threshold), the display control unit 72 changes the ratio of the dark-colored portions 100A of the marker 100 along the vehicle width direction to an intermediate level and changes the remaining portions excluding the dark-colored portions 100A to light-colored portions 100B as illustrated in FIG. 11B and FIG. 12B. Furthermore, in a case in which the vehicle width direction confidence value in the perception of the position of the preceding vehicle is less than the second threshold, the display control unit 72 changes the ratio of the light-colored portions 100B of the marker 100 along the vehicle width direction to 100% as illustrated in FIG. 11C and FIG. 12C. In this way, by changing the ratio of the dark-colored portions 100A to the light-colored portions 100B of the marker 100 along the vehicle width direction in accordance with the vehicle width direction confidence value in the perception of the position of the preceding vehicle as described above, the user may be made intuitively aware of the vehicle width direction confidence value associated with the perception of the position of the preceding vehicle.

The processes of the next steps 214 and 220 are as described in the first embodiment, so detailed description thereof will be omitted.

In this way, in the second embodiment, the display control unit 72 acquires confidence values associated with the perception of the position of the preceding vehicle and changes the display mode of the marker 100 based on the acquired confidence values associated with the perception of the position of the preceding vehicle. Because of this, the user may be made aware of the confidence values associated with the perception of the position of the preceding vehicle.

Furthermore, in the second embodiment, the display control unit 72 acquires the vehicle vertical direction confidence value associated with the perception of the position of the preceding vehicle and changes the display mode of the marker 100 by changing the vehicle vertical direction width of the marker 100 based on the acquired vehicle vertical direction confidence value associated with the perception of the position of the preceding vehicle. Because of this, a simple change to the display mode in which the vehicle vertical direction width of the marker 100 is changed may make the user aware of the vehicle vertical direction confidence value associated with the perception of the position of the preceding vehicle.

Furthermore, in the second embodiment, the display control unit 72 increases the vehicle vertical direction width of the marker 100 as the acquired vehicle vertical direction confidence value associated with the perception of the position of the preceding vehicle becomes lower. Because of this, the user may be made intuitively aware of the vehicle vertical direction confidence value associated with the perception of the position of the preceding vehicle, and offset in the position of the marker 100 relative to the preceding vehicle may be inhibited from being clearly perceived in a case in which the vehicle vertical direction confidence value associated with the perception of the position of the preceding vehicle is low.

Moreover, in the second embodiment, the display control unit 72 acquires the vehicle width direction confidence value associated with the perception of the position of the preceding vehicle and changes the display mode of the marker 100 by changing shades of color of the marker 100 in the vehicle width direction based on the acquired vehicle width direction confidence value associated with the perception of the position of the preceding vehicle. Because of this, a simple change to the display mode in which shades of color of the marker 100 are changed in the vehicle width direction may make the user aware of the vehicle width direction confidence value associated with the perception of the position of the preceding vehicle.

Furthermore, in the second embodiment, the display control unit 72 increases the ratio, along the vehicle width direction, of light-colored portions of the marker 100 where the color is light as the acquired vehicle width direction confidence value associated with the perception of the position of the preceding vehicle becomes lower. Because of this, the user may be made intuitively aware of the vehicle width direction confidence value associated with the perception of the position of the preceding vehicle.

### Third Embodiment

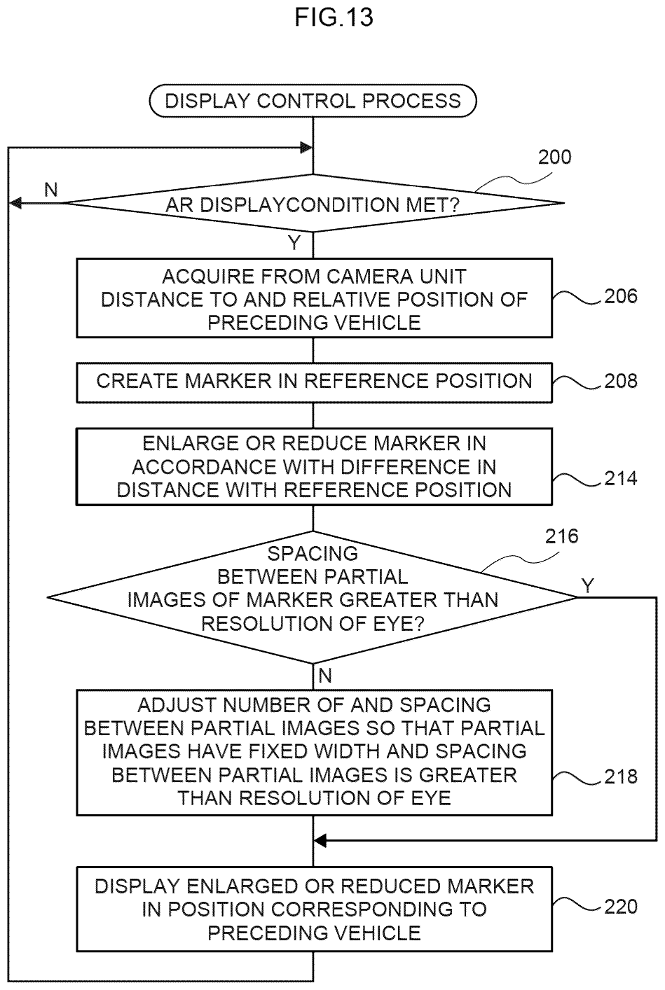

Next, a third embodiment of the present disclosure will be described. It will be noted that the present third embodiment has similar configurations to the first embodiment and, therefore, parts are assigned the same reference signs and description thereof will be omitted. The display control process pertaining to the third embodiment will be described with reference to FIG. 13.

In the display control process pertaining to the third embodiment, as in the first embodiment, in a case in which the display control unit 72 has determined that the AR display condition is met (in a case in which the determination of step 200 is YES), the display control ECU 42 (or the display control unit 72) acquires from the camera unit 24 the distance to the preceding vehicle and relative position in the vehicle width direction of the preceding vehicle (step S206). Furthermore, the display control unit 72 creates the marker 100 in the reference position (step 208) and enlarges or reduces the marker 100 in accordance with the difference in distance between the distance to the preceding vehicle and the reference distance (step 214).

As a result of the above process, the image of the marker 100 is reduced as the distance between the host vehicle and the preceding vehicle increases and the marker 100 is displayed in the display area 74 of the AR-HUD 56. Because of this, the spacing between the partial images 102 of the marker 100 becomes smaller as the distance between the host vehicle and the preceding vehicle increases, and may become equal to or less than the resolution of the human eye (e.g., roughly 1/60 deg). In this case, as indicated by the notation in FIG. 14C, “Spacing between partial images cannot be perceived in case of far-distance display; size of spacing<resolution of eye ( 1/60 deg),” the entire marker 100 is more likely to be perceived as a single image in the perception of the marker by the user.

Therefore, in the next step 216, the display control unit 72 determines whether the spacing between the partial images 102 of the marker 100 that has been enlarged or reduced in step 214 is greater than the resolution of the human eye (e.g., roughly 1/60 deg). Here, in a case in which the distance between the host vehicle and the preceding vehicle is relatively small, the determination of step 216 becomes NO and the display control unit 72 moves to step 220. Consequently, in this case, the marker 100 that has been enlarged or reduced in step 214 is displayed as is in the position corresponding to the image 90 of the preceding vehicle (see also the marker 100 shown in FIG. 14A with the notation “Near-distance Display”).

In a case in which the distance between the host vehicle and the preceding vehicle is relatively large, the determination of step 216 becomes YES and the display control unit 72 moves to step 218. In step 218, the display control unit 72 adjusts the number of and spacing between the partial images 102 so that the partial images 102 have a fixed width and the spacing between the partial images 102 is greater than the resolution of the human eye. As a result, as indicated by the notation in FIG. 14C, “Spacing between partial images can be perceived even with far-distance display by increasing marker spacing and reducing number of partial images; size of spacing>resolution of eye ( 1/60 deg),” the spacing between the partial images 102 of the marker 100 is made greater than the resolution of the human eye.

It will be noted that in response to the process of step 218, the number of the partial images 102 is reduced in stages as the distance between the host vehicle and the preceding vehicle increases, and the spacing between the partial images 102 is increased in stages as the distance between the host vehicle and the preceding vehicle increases (see also FIG. 14B). However, the number of and spacing between the partial images 102 may also be continuously changed as the distance between the host vehicle and the preceding vehicle increases.

After performing the process of step 218, the display control unit 72 moves to step 220. Consequently, in this case, the marker 100 that has been enlarged or reduced in step 214 is displayed with the partial images 102 thinned out in the position corresponding to the image 90 of the preceding vehicle (see also the marker 100 shown in FIG. 14A with the notation “Far-distance Display”). As a result, the entire marker 100 is less likely to be perceived as a single image in the perception of the marker by the user and offset in the position of the marker 100 relative to the preceding vehicle may be inhibited from being clearly perceived even in a case in which the distance between the host vehicle and the preceding vehicle is relatively large.

In this way, in the third embodiment, the display control unit 72 reduces the image of the marker 100 as the distance between the host vehicle and the preceding vehicle increases and causes the marker 100 to be displayed in the display area 74 of the AR-HUD 56, and at the same time adjusts the spacing between the partial images 102 along the vehicle width direction and the number of the partial images 102 so that the spacing, along the vehicle width direction, between the partial images 102 in the reduced image of the marker 100 becomes greater than the resolution of the eye. Therefore, the entire marker 100 is inhibited from being perceived as a single image and offset in the position of the marker relative to the preceding vehicle may be inhibited from being clearly perceived even in a case in which the distance between the host vehicle and the preceding vehicle is large.

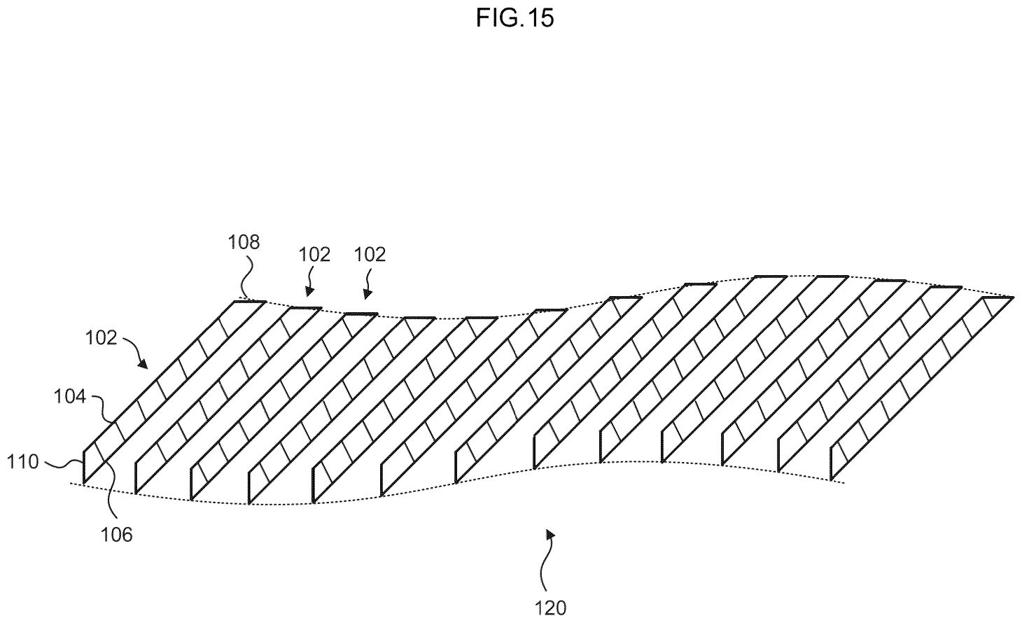

In the above embodiments, an aspect has been described in which the vehicle vertical direction positions of the sides 108, 110 of the plural partial images 102 configuring the marker 100 are aligned in straight lines (see FIG. 4). However, the marker pertaining to the present disclosure is not limited to the plural partial images 102 being arranged as described above. For example, as in a marker 120 shown in FIG. 15, the plural partial images 102 may also be arranged so that the vehicle vertical direction positions of the sides 108, 110 of the plural partial images 102 periodically change in the vehicle vertical direction.

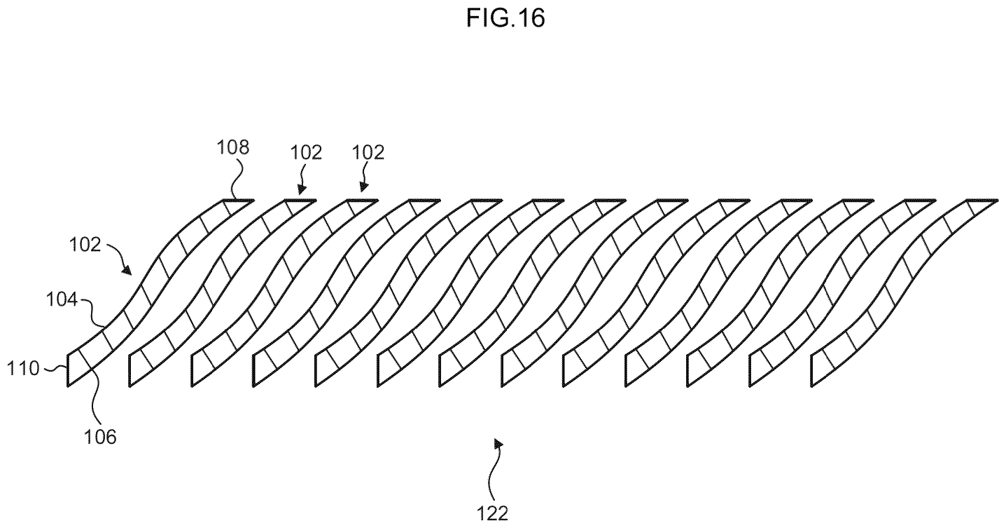

Furthermore, in the above embodiments, an aspect has been described in which the sides 104, 106 of each of the individual partial images 102 configuring the marker 100 are linear. However, the marker in the present disclosure is not limited to the sides of each of the individual partial images being linear. For example, as in a marker 122 illustrated in FIG. 16, the sides 104, 106 of each of the individual partial images 102 configuring the marker 122 may also be curved.

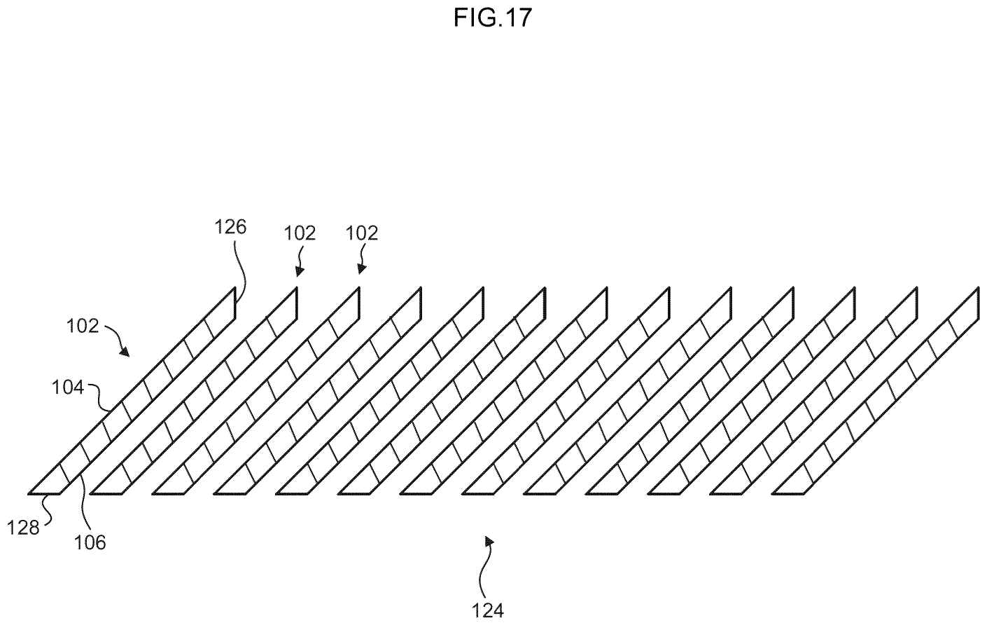

Furthermore, in the above embodiments, an aspect has been described in which each of the individual partial images 102 configuring the marker 100 has a shape where the vehicle vertical direction upper end portions of the sides 104, 106 are interconnected by the side 108 that is parallel to the vehicle width direction and the vehicle vertical direction lower end portions of the sides 104, 106 are interconnected by the side 110 that is parallel to the vehicle vertical direction (see FIG. 4). However, the marker pertaining to the present disclosure is not limited to each of the individual partial images having the above-described shape. For example, as in a marker 124 illustrated in FIG. 17, the partial images 102 may also each have a shape where the vehicle vertical direction upper end portions of the sides 104, 106 are interconnected by a side 126 that is parallel to the vehicle vertical direction and the vehicle vertical direction lower end portions of the sides 104, 106 are interconnected by a side 128 that is parallel to the vehicle width direction.

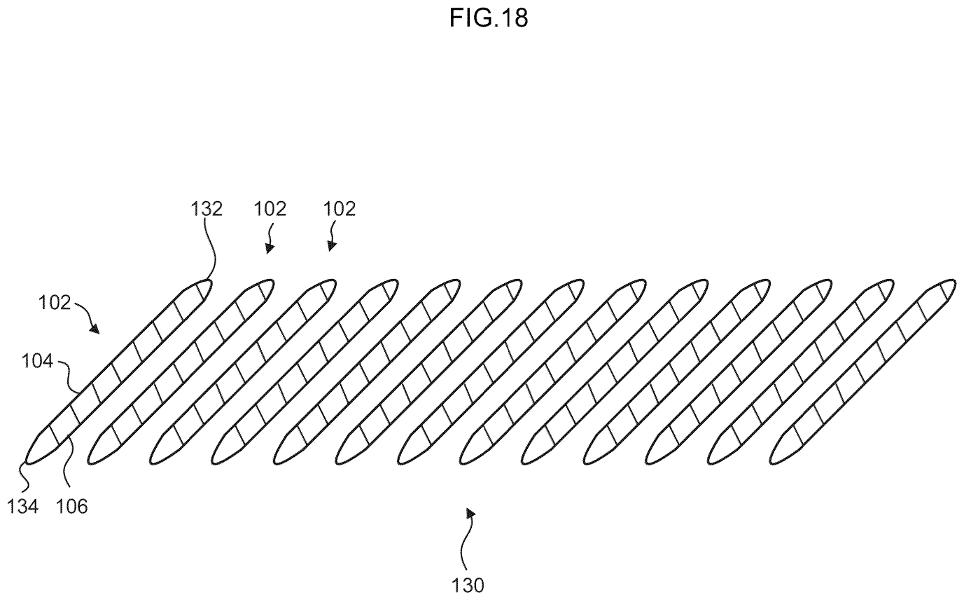

Moreover, as in a marker 130 illustrated in FIG. 18 as an example, the partial images 102 may also each have a shape where the vehicle vertical direction upper end portions of the sides 104, 106 are interconnected by an arc-shaped side 132 and the vehicle vertical direction lower end portions of the sides 104, 106 are interconnected by an arc-shaped side 134.

It will be noted that the aforementioned markers 120, 122, 124, 130 are examples of “a marker comprising a plurality of partial images lined up next to and spaced apart from each other in a vehicle width direction and having sides along a lengthwise direction of the partial images that are not parallel to a vehicle vertical direction.”

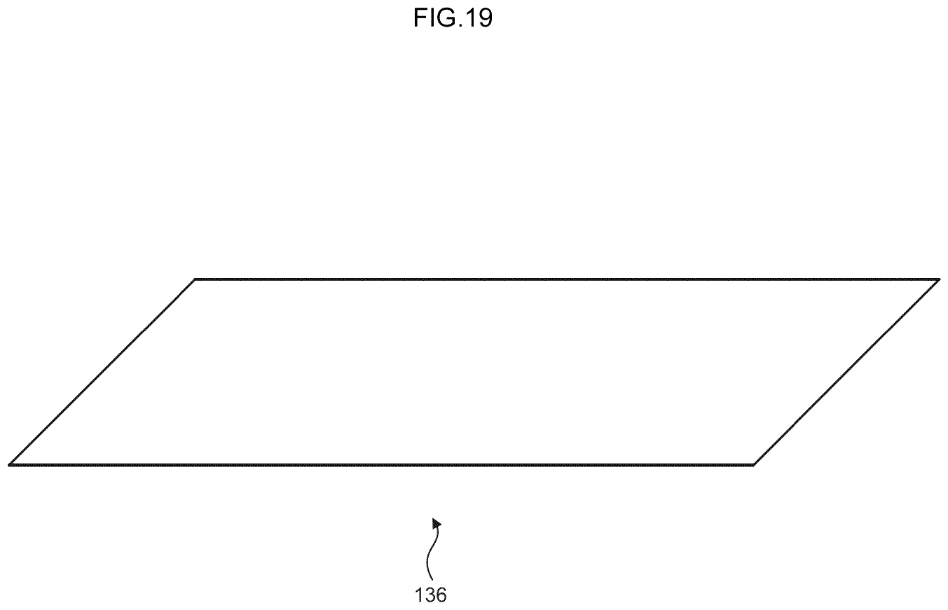

Furthermore, in the above embodiments, an aspect has been described in which the marker 100 is configured by the plural partial images 102 that are arranged a spacing apart from each other. However, the marker pertaining to the present disclosure is not limited to being configured from plural partial images. For example, as in a marker 136 illustrated in FIG. 19, the marker may also be configured by a single marker having a parallelogram shape in which the plural partial images 102 are integrated. It will be noted that the marker 136 is an example of “a marker having a polygonal shape with short sides that are positioned on vehicle width direction end portion sides of the marker and are not parallel to a vehicle vertical direction.”

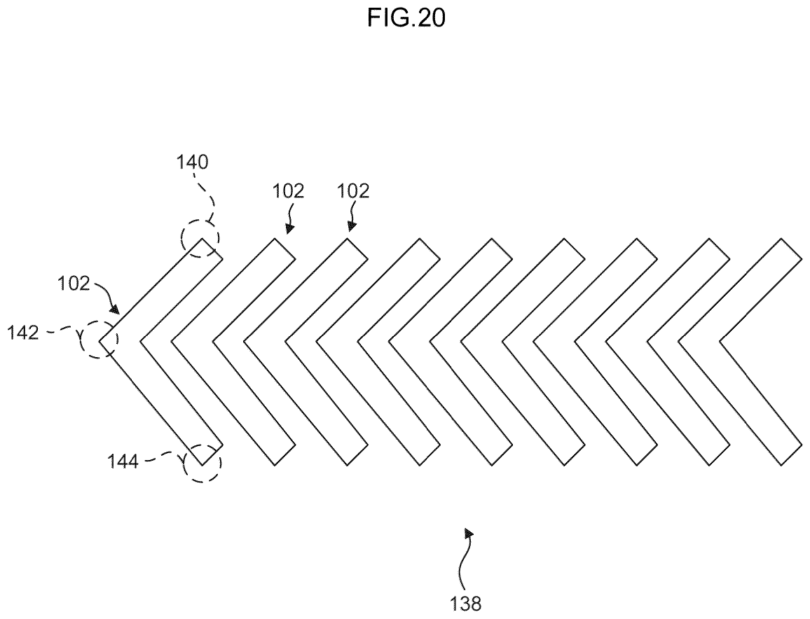

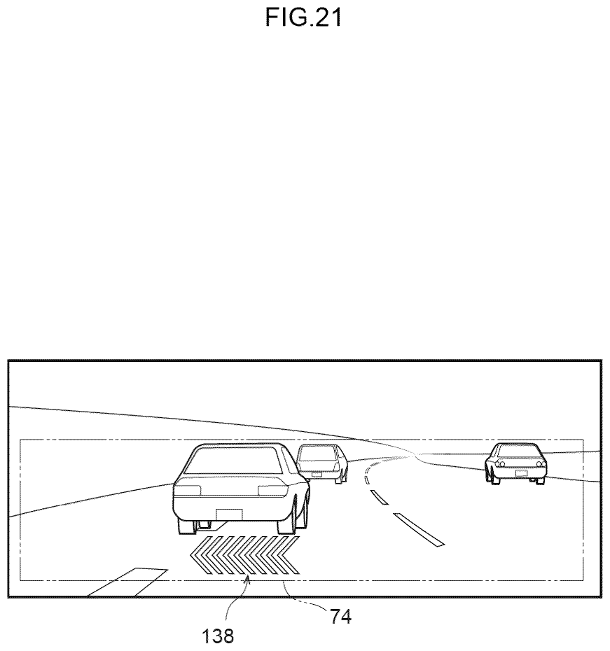

Furthermore, in the above embodiments, an aspect has been described in which each of the individual partial images 102 configuring the marker 100 are roughly rod-shaped. However, the marker pertaining to the present disclosure may, as in a marker 138 illustrated in FIG. 20 and FIG. 21 for example, also have a configuration where each of the individual partial images 102 is roughly V-shaped and rotated clockwise 90° and where the partial images 102 are arranged a predetermined spacing apart from each other. On the vehicle width direction left end of the marker 138, for example, the edges inside the three ranges indicated by reference signs 140, 142, 144 in FIG. 20 are interpreted as reference points in the perception of the marker by the user. However, in the marker 138, particularly the edge inside the range 142 is, due to its positional relationship, interpreted more strongly as a reference point than the edges inside the other ranges 140, 144. Therefore, compared with the marker 100 etc., the effect of inhibiting offset in the position of the marker 138 relative to the image 90 of the preceding vehicle from being clearly perceived by the user becomes lower. Nevertheless, the marker pertaining to the present disclosure also includes in its scope the marker 138 shown in FIG. 20.

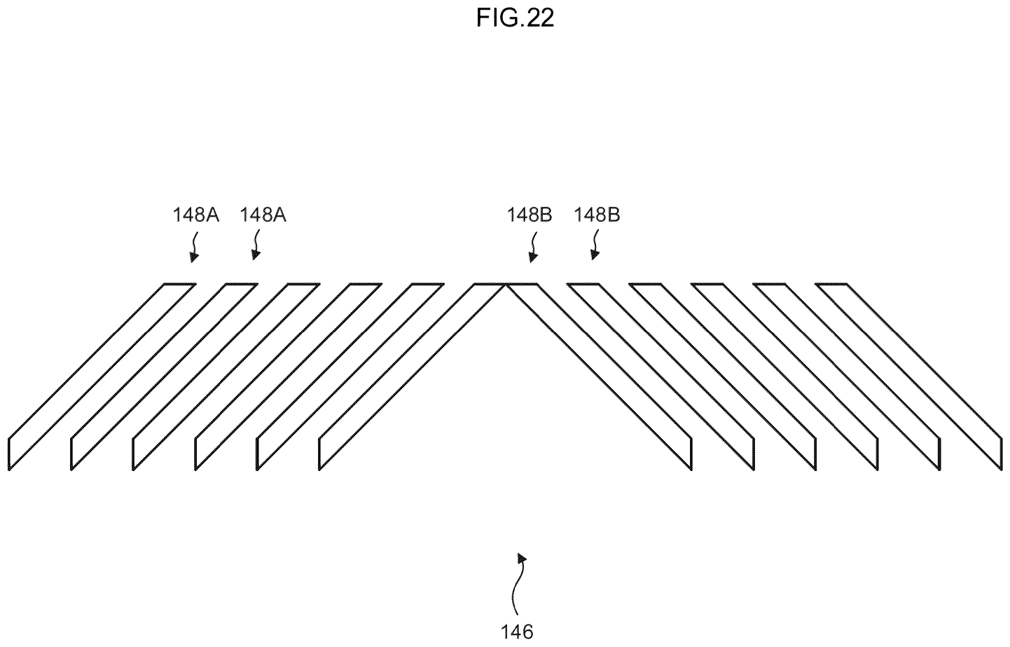

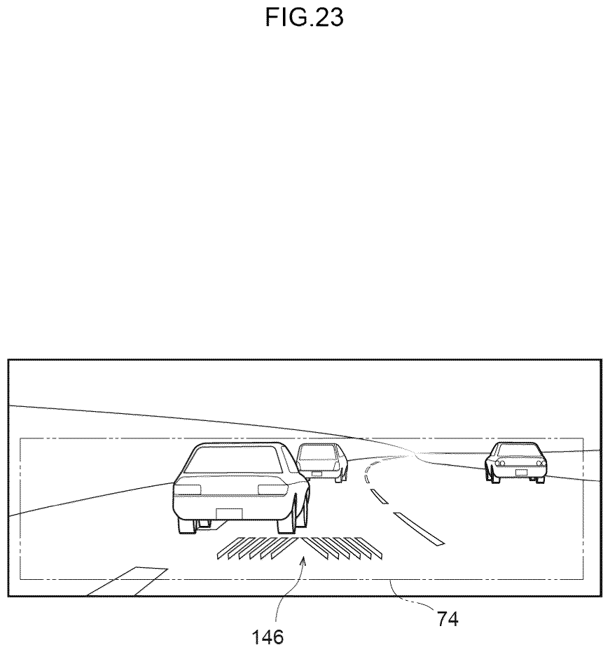

Furthermore, in the above embodiments, an aspect has been described in which the marker 100 is bilaterally asymmetrical in the vehicle width direction. However, the marker pertaining to the present disclosure may, as in a marker 146 illustrated in FIG. 22 and FIG. 23 for example, have a shape where partial images 148A that are roughly rod-shaped and inclined about 45° clockwise relative to the vertical direction and partial images 148B that are roughly rod-shaped and inclined about 45° counterclockwise relative to the vertical direction are arranged bilaterally symmetrically across the vehicle width direction center portion of the marker 146.

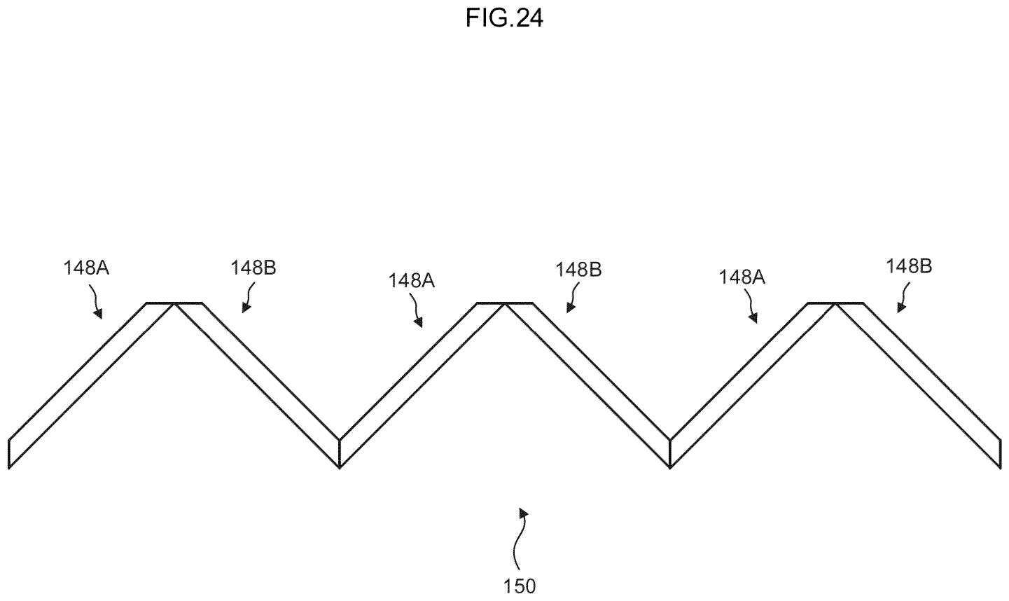

Furthermore, as in a marker 150 illustrated in FIG. 24 and FIG. 25 for example, the marker may also have a configuration in which partial images 148A and partial images 148B are arranged so as to alternately appear along the vehicle width direction. The markers 146, 150 illustrated in FIG. 22 to FIG. 25 are bilaterally symmetrical in the vehicle width direction, and the vehicle width direction center portions of the markers 146, 150 are more likely to be interpreted as reference points in the perception of the marker by the user. Therefore, compared with the marker 100 etc., the effect of inhibiting offset in the vehicle width direction position of the markers 146, 150 relative to the image 90 of the preceding vehicle from being clearly perceived by the user becomes lower. Nevertheless, the marker pertaining to the present disclosure also includes in its scope of rights the markers 146, 150 shown in FIG. 22 to FIG. 24.

It will be noted that the aforementioned markers 138, 146, 150 are also examples of “a marker comprising a plurality of partial images lined up next to and spaced apart from each other in a vehicle width direction and having sides along a lengthwise direction of the partial images that are not parallel to a vehicle vertical direction.”

Moreover, in the above embodiments, a case has been described in which the object in the present disclosure is a preceding vehicle. However, the object pertaining to the present disclosure may be an object other than a preceding vehicle, such as a pedestrian for example.

Furthermore, in the above embodiments, an aspect has been described in which the display control unit 72 causes the marker 100 etc. to be displayed in a position corresponding to an object included in the foreground of the vehicle visible through the display area 74 of the AR-HUD 56. However, the present disclosure is not limited to this. For example, the AR-HUD 56 may be configured to display an image resembling the foreground of the host vehicle in the display area 74 of the AR-HUD 56, and the display control unit 72 may cause the marker 100 etc. to be displayed in a position corresponding to an object included in the image resembling the foreground of the vehicle. Furthermore, in the above embodiments, an aspect has been described in which the AR-HUD 56 is applied as an example of the display device in the present disclosure. However, the present disclosure is not limited to this, and the display device in the present disclosure may also be the meter display 68.

Furthermore, in the above description an aspect has been described in which the display control program 54, which is an example of the display control program pertaining to the present disclosure, is stored (installed) beforehand in the storage unit 48. However, the display control program pertaining to the present disclosure may also be provided in a form in which it is recorded in a non-transitory recording medium such as an HDD, SSD, or DVD.

The following supplementary notes are also disclosed in relation to the above embodiments.

### (Supplementary Note 1)

A display control device including a display control unit that causes a marker to be displayed in a display area of a display device in a position corresponding to an object included in a foreground of a vehicle visible through the display area of the display device or in an image resembling the foreground of the vehicle displayed in the display area of the display device, the marker comprising a plurality of partial images lined up next to and spaced apart from each other in a vehicle width direction and having sides along a lengthwise direction of the partial images that are not parallel to a vehicle vertical direction.

### (Supplementary Note 2)

A display control device including a display control unit that causes a marker to be displayed in a display area of a display device in a position corresponding to an object included in a foreground of a vehicle visible through the display area of the display device or in an image resembling the foreground of the vehicle displayed in the display area of the display device, the marker having a polygonal shape with short sides that are positioned on vehicle width direction end portion sides of the marker and are not parallel to a vehicle vertical direction.

### (Supplementary Note 3)

The display control device of supplementary note 1, wherein the partial images are arranged at an even spacing in the vehicle width direction.

### (Supplementary Note 4)

The display control device of supplementary note 1 or supplementary note 3, wherein the partial images each have a shape where one of a vehicle vertical direction upper end portion and lower end portion of the partial image is parallel to the vehicle width direction while the other is parallel to the vehicle vertical direction.

### (Supplementary Note 5)

The display control device of any one of supplementary note 1 to supplementary note 4, wherein the marker is bilaterally asymmetrical in the vehicle width direction.

### (Supplementary Note 6)

The display control device of any one of supplementary note 1 to supplementary note 5, wherein the display control unit acquires a confidence value associated with perception of the position of the object and changes the display mode of the marker based on the acquired confidence value.

### (Supplementary Note 7)

The display control device of supplementary note 6, wherein the display control unit acquires a vehicle vertical direction confidence value associated with perception of the position of the object and changes the display mode of the marker by changing the vehicle vertical direction width of the marker based on the acquired vehicle vertical direction confidence value.

### (Supplementary Note 8)

The display control device of supplementary note 7, wherein the display control unit increases the vehicle vertical direction width of the marker as the acquired vehicle vertical direction confidence value becomes lower.

### (Supplementary Note 9)

The display control device of supplementary note 6, wherein the display control unit acquires a vehicle width direction confidence value associated with perception of the position of the object and changes the display mode of the marker by changing shades of color of the marker in the vehicle width direction based on the acquired vehicle width direction confidence value.

### (Supplementary Note 10)

The display control device of supplementary note 9, wherein the display control unit increases the ratio, along the vehicle width direction, of light-colored portions of the marker such that the color is light as the acquired vehicle width direction confidence value becomes lower.

### (Supplementary Note 11)

The display control device of any one of supplementary note 1 or supplementary note 3 to supplementary note 10, wherein the display control unit reduces an image of the marker as the distance between the vehicle and the object increases and causes the marker to be displayed in the display area of the display device, and adjusts the spacing between the partial images along the vehicle width direction and the number of the partial images so that the spacing, along the vehicle width direction, between the partial images in the reduced image of the marker becomes greater than the resolution of the eye.

### (Supplementary Note 12)

The display control device of any one of supplementary note 1 to supplementary note 11, wherein the display device is a head-up display.

### (Supplementary Note 13)

A display control method that causes a computer to execute a process including causing a marker to be displayed in a display area of a display device in a position corresponding to an object included in a foreground of a vehicle visible through the display area of the display device or in an image resembling the foreground of the vehicle displayed in the display area of the display device, the marker comprising a plurality of partial images lined up next to and spaced apart from each other in a vehicle width direction and having sides along a lengthwise direction of the partial images that are not parallel to a vehicle vertical direction.

### (Supplementary Note 14)

A display control method that causes a computer to execute a process including causing a marker to be displayed in a display area of a display device in a position corresponding to an object included in a foreground of a vehicle visible through the display area of the display device or in an image resembling the foreground of the vehicle displayed in the display area of the display device, the marker having a polygonal shape with short sides that are positioned on vehicle width direction end portion sides of the marker and are not parallel to a vehicle vertical direction.

### (Supplementary Note 15)

The display control method of supplementary note 13, wherein the partial images are arranged at an even spacing in the vehicle width direction.

### (Supplementary Note 16)

The display control method of supplementary note 13 or supplementary note 15, wherein the partial images each have a shape where one of a vehicle vertical direction upper end portion and lower end portion of the partial image is parallel to the vehicle width direction while the other is parallel to the vehicle vertical direction.

### (Supplementary Note 17)

The display control method of supplementary note 13 or supplementary note 14, wherein the marker is bilaterally asymmetrical in the vehicle width direction.

### (Supplementary Note 18)

The display control method of supplementary note 13 or supplementary note 14, wherein the display control unit acquires a confidence value associated with perception of the position of the object and changes the display mode of the marker based on the acquired confidence value.

### (Supplementary Note 19)

The display control method of supplementary note 18, wherein the display control unit acquires a vehicle vertical direction confidence value associated with perception of the position of the object and changes the display mode of the marker by changing the vehicle vertical direction width of the marker based on the acquired vehicle vertical direction confidence value.

### (Supplementary Note 20)

The display control method of supplementary note 19, wherein the display control unit increases the vehicle vertical direction width of the marker as the acquired vehicle vertical direction confidence value becomes lower.

### (Supplementary Note 21)

The display control method of supplementary note 18, wherein the display control unit acquires a vehicle width direction confidence value associated with perception of the position of the object and changes the display mode of the marker by changing shades of color of the marker in the vehicle width direction based on the acquired vehicle width direction confidence value.

### (Supplementary Note 22)

The display control method of supplementary note 21, wherein the display control unit increases the ratio, along the vehicle width direction, of light-colored portions of the marker such that the color is light as the acquired vehicle width direction confidence value becomes lower.

### (Supplementary Note 23)

The display control method of any one of supplementary note 13 and supplementary note 15 to supplementary note 22, wherein the display control unit reduces an image of the marker as the distance between the vehicle and the object increases and causes the marker to be displayed in the display area of the display device, and adjusts the spacing between the partial images along the vehicle width direction and the number of the partial images so that the spacing, along the vehicle width direction, between the partial images in the reduced image of the marker becomes greater than the resolution of the eye.

### (Supplementary Note 24)

The display control method of any one of supplementary note 13 to supplementary note 23, wherein the display device is a head-up display.

### (Supplementary Note 25)

A display control program for causing a computer to execute a process including causing a marker to be displayed in a display area of a display device in a position corresponding to an object included in a foreground of a vehicle visible through the display area of the display device or in an image resembling the foreground of the vehicle displayed in the display area of the display device, the marker comprising a plurality of partial images lined up next to and spaced apart from each other in a vehicle width direction and having sides along a lengthwise direction of the partial images that are not parallel to a vehicle vertical direction.

### (Supplementary Note 26)

A display control program for causing a computer to execute a process including causing a marker to be displayed in a display area of a display device in a position corresponding to an object included in a foreground of a vehicle visible through the display area of the display device or in an image resembling the foreground of the vehicle displayed in the display area of the display device, the marker having a polygonal shape with short sides that are positioned on vehicle width direction end portion sides of the marker and are not parallel to a vehicle vertical direction.

### (Supplementary Note 27)

The display control program of supplementary note 25, wherein the partial images are arranged at an even spacing in the vehicle width direction.

### (Supplementary Note 28)

The display control program of supplementary note 25 or supplementary note 27, wherein the partial images each have a shape where one of a vehicle vertical direction upper end portion and lower end portion of the partial image is parallel to the vehicle width direction while the other is parallel to the vehicle vertical direction.

### (Supplementary Note 29)

The display control program of supplementary note 25 or supplementary note 26, wherein the marker is bilaterally asymmetrical in the vehicle width direction.

### (Supplementary Note 30)

The display control program of supplementary note 25 or supplementary note 26, wherein the display control unit acquires a confidence value associated with perception of the position of the object and changes the display mode of the marker based on the acquired confidence value.

### (Supplementary Note 31)

The display control program of supplementary note 30, wherein the display control unit acquires a vehicle vertical direction confidence value associated with perception of the position of the object and changes the display mode of the marker by changing the vehicle vertical direction width of the marker based on the acquired vehicle vertical direction confidence value.

### (Supplementary Note 32)

The display control program of supplementary note 31, wherein the display control unit increases the vehicle vertical direction width of the marker as the acquired vehicle vertical direction confidence value becomes lower.

### (Supplementary Note 33)

The display control program of supplementary note 30, wherein the display control unit acquires a vehicle width direction confidence value associated with perception of the position of the object and changes the display mode of the marker by changing shades of color of the marker in the vehicle width direction based on the acquired vehicle width direction confidence value.

### (Supplementary Note 34)

The display control program of supplementary note 33, wherein the display control unit increases the ratio, along the vehicle width direction, of light-colored portions of the marker such that the color is light as the acquired vehicle width direction confidence value becomes lower.

### (Supplementary Note 35)

The display control program of any one of supplementary note 25 or supplementary note 27 to supplementary note 34, wherein the display control unit reduces an image of the marker as the distance between the vehicle and the object increases and causes the marker to be displayed in the display area of the display device, and adjusts the spacing between the partial images along the vehicle width direction and the number of the partial images so that the spacing, along the vehicle width direction, between the partial images in the reduced image of the marker becomes greater than the resolution of the eye.

### (Supplementary Note 36)

The display control program of any one of supplementary note 25 to supplementary note 35, wherein the display device is a head-up display.

What is claimed is:

1. A display control device comprising:
a memory; and
a processor coupled to the memory and configured to
display a marker in a display area of a display device in a position corresponding to an object included in a foreground of a vehicle visible through the display area of the display device or in an image resembling the foreground of the vehicle displayed in the display area of the display device,
wherein the marker comprising a plurality of partial images lined up next to and spaced apart from each other in a vehicle width direction and having sides along a lengthwise direction of the partial images that are not parallel to a vehicle vertical direction.

2. The display control device of claim 1, wherein the partial images are arranged at an even spacing in the vehicle width direction.

3. The display control device of claim 1, wherein the partial images each have a shape where one of a vehicle vertical direction upper end portion and lower end portion of the partial image is parallel to the vehicle width direction, while the other is parallel to the vehicle vertical direction.

4. The display control device of claim 1, wherein the marker is bilaterally asymmetrical in the vehicle width direction.

5. The display control device of claim 1, wherein the processor is configured to:
acquire a confidence value associated with perception of the position of the object; and
change a display mode of the marker based on the acquired confidence value.

6. The display control device of claim 5, wherein the processor is configured to:
acquire a vehicle vertical direction confidence value associated with perception of the position of the object; and
change the display mode of the marker by changing a vehicle vertical direction width of the marker based on the acquired vehicle vertical direction confidence value.

7. The display control device of claim 6, wherein the processor is configured to increase the vehicle vertical direction width of the marker as the acquired vehicle vertical direction confidence value becomes lower.

8. The display control device of claim 5, wherein the processor is configured to:
acquire a vehicle width direction confidence value associated with perception of the position of the object; and
change the display mode of the marker by changing shades of color of the marker in the vehicle width direction based on the acquired vehicle width direction confidence value.

9. The display control device of claim 8, wherein the processor is configured to increase a ratio, along the vehicle width direction, of light-colored portions of the marker such that the color is light as the acquired vehicle width direction confidence value becomes lower.

10. The display control device of claim 1, wherein the processor is configured to:
reduce an image of the marker as a distance between the vehicle and the object increases and display the marker in the display area of the display device; and
adjust the spacing between the partial images along the vehicle width direction and the number of the partial images so that the spacing, along the vehicle width direction, between the partial images in the reduced image of the marker becomes greater than a resolution of an eye.

11. The display control device of claim 1, wherein the display device is a head-up display.

12. A display control device comprising:
a memory; and
a processor coupled to the memory and configured to
display a marker in a display area of a display device in a position corresponding to an object included in a foreground of a vehicle visible through the display area of the display device or in an image resembling the foreground of the vehicle displayed in the display area of the display device,
wherein the marker having a polygonal shape with short sides that are positioned on vehicle width direction end portion sides of the marker and are not parallel to a vehicle vertical direction.

13. The display control device of claim 12, wherein the marker is bilaterally asymmetrical in the vehicle width direction.

14. The display control device of claim 12, wherein the processor is configured to:
acquire a confidence value associated with perception of the position of the object; and
change a display mode of the marker based on the acquired confidence value.

15. The display control device of claim 14, wherein the processor is configured to:
acquire a vehicle vertical direction confidence value associated with perception of the position of the object; and
change the display mode of the marker by changing a vehicle vertical direction width of the marker based on the acquired vehicle vertical direction confidence value.

16. The display control device of claim 15, wherein processor is configured to increase the vehicle vertical direction width of the marker as the acquired vehicle vertical direction confidence value becomes lower.

17. The display control device of claim 14, wherein the processor is configured to:
acquire a vehicle width direction confidence value associated with perception of the position of the object; and
change the display mode of the marker by changing shades of color of the marker in the vehicle width direction based on the acquired vehicle width direction confidence value.

18. The display control device of claim 17, wherein the processor is configured to increase a ratio, along the vehicle width direction, of light-colored portions of the marker such that the color is light as the acquired vehicle width direction confidence value becomes lower.

19. The display control device of claim 12, wherein the display device is a head-up display.

20. A display control method that causes a computer to execute a process comprising causing a marker to be displayed in a display area of a display device in a position corresponding to an object included in a foreground of a vehicle visible through the display area of the display device or in an image resembling the foreground of the vehicle displayed in the display area of the display device,
wherein the marker comprising a plurality of partial images lined up next to and spaced apart from each other in a vehicle width direction and having sides along a lengthwise direction of the partial images that are not parallel to a vehicle vertical direction.

21. A display control method that causes a computer to execute a process comprising causing a marker to be displayed in a display area of a display device in a position corresponding to an object included in a foreground of a vehicle visible through the display area of the display device or in an image resembling the foreground of the vehicle displayed in the display area of the display device,
wherein the marker having a polygonal shape with short sides that are positioned on vehicle width direction end portion sides of the marker and are not parallel to a vehicle vertical direction.

22. A non-transitory storage medium storing a program that causes a computer to execute display control processing, the display control processing comprising causing a marker to be displayed in a display area of a display device in a position corresponding to an object included in a foreground of a vehicle visible through the display area of the display device or in an image resembling the foreground of the vehicle displayed in the display area of the display device,
wherein the marker comprising a plurality of partial images lined up next to and spaced apart from each other in a vehicle width direction and having sides along a lengthwise direction of the partial images that are not parallel to a vehicle vertical direction.

23. A non-transitory storage medium storing a program that causes a computer to execute display control processing, the display control processing comprising causing a marker to be displayed in a display area of a display device in a position corresponding to an object included in a foreground of a vehicle visible through the display area of the display device or in an image resembling the foreground of the vehicle displayed in the display area of the display device,
wherein the marker having a polygonal shape with short sides that are positioned on vehicle width direction end portion sides of the marker and are not parallel to a vehicle vertical direction.
